(19) United States
(12) Patent Application Publication
(10) Pub. No.: US 2024/0034184 A1
(43) Pub. Date: Feb. 1, 2024

(54) METHOD FOR MINIMIZING ELECTRIC VEHICLE OUTAGE

(71) Applicant: KING FAHD UNIVERSITY OF PETROLEUM AND MINERALS, Dhahran (SA)

(72) Inventors: Mohammed Hadi AL GAFRI, Dhahran (SA); Uthman BAROUDI, Dhahran (SA)

(73) Assignee: KING FAHD UNIVERSITY OF PETROLEUM AND MINERALS, Dhahran (SA)

(21) Appl. No.: 17/878,127

(22) Filed: Aug. 1, 2022

(51) Int. Cl. B60L 53/68; B60L 53/67; B60L 53/66; B60L 53/30; B60L 53/63

(52) U.S. Cl. CPC B60L 53/68; B60L 53/67; B60L 53/66; B60L 53/305; B60L 53/63

(57) ABSTRACT

A system, method, and non-transitory computer readable medium that assigns an electric vehicle to a charging station is described. The system includes a software-defined networking (SDN) controller application stored in a cloud-based computing platform, a computing device stored in the cloud platform, and a fog and cloud-based charging service application stored in the computing device. The SDN controller application is linked to a plurality of fog servers and is configured to manage network communications between the fog servers and the cloud-based computing platform, between the fog and a number S of charging stations CSₛ, where s=1, 2, . . . , S, and between the fog and a number I of electric vehicles EVᵢ, where I=1, 2, . . . , I. The fog and cloud-based charging service application determines an optimal charging station CSₒₚₜ for each electric vehicle and transmits a route to the optimal charging station to the EVᵢ.

### BACKGROUND

### Technical Field

The present disclosure is directed to a method, system and apparatus for minimizing electric vehicle outage, especially assigning and budgeting energy for electrical vehicle charging and charging station availability.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Demand and usage of electric vehicles has increased all over the world due to climate changes, fossil fuel shortages, increasing fuel prices, greenhouse gas emissions, and reduced air quality. In recent years, the number of electric vehicles has grown rapidly, and therefore, charge management of the electric vehicles has become a major challenge. Charge management of electric vehicles (EVs) faces several issues, such as reliability, demand/supply, battery degradation, range anxiety, and computation capacity. Also, during peak hours, when a large number of EVs are connected to a power grid, there may be a sharp increase in power demand from the power grid, which may affect the stability and safety of the power grid. Therefore, it is necessary to coordinate and control the charging of the electric vehicles such that load fluctuations on the power grid may be reduced.

Existing solutions for guiding a user to charging locations for electric vehicles are based on a query-based approach in which a user requests nearby charging stations, and positions of nearby available charging stations are marked on a map. However, these systems are limited to the search quality of the query and depend on a single factor, the shortest path length. Therefore, conventional solutions may not be able to provide cost savings and timely quality of service.

As the number of charging stations is limited, all available charging stations electric vehicle charging stations on the user's route should be considered, along with a calculation of a reservation time at which the user can use the services. Charging stations with long waiting times should be avoided in order to reduce the overall charging time. A primary challenge in the development of electric vehicle infrastructure is a lack of a cooperative charging decision system which accounts for many factors, such as the number of charging stations along a user's route, the wait time for service, the price of electricity, the distances to the locations and the number of chargers at each charging station, the capacity of the chargers, the number of requests for charging service by other EVs along the route, the locations of the requests, arrival and departure times, and demand per EV.

A wireless real-time communication network may be adapted for communication between EVs and a local station controller installed for every charging station. The wireless real-time communication network may communicate with a central station controller situated on a cloud platform for EV charging and discharging at public stations. For both vehicle to grid (V2G) and grid to vehicle (G2V) charging services, EVs can communicate wirelessly with a smart grid (SG) through a roadside communication device, such as a WiFi unit, and all electric vehicle supply equipment (EVSEs) are connected by known communication technologies. However, this wireless real-time communication network fails to provide an acceptable solution for charging/discharging scheduling which balances the aforementioned factors.

A solution to incorporating the aforementioned factors into a charging schedule may include software-defined networking (SDN), which is an architecture that abstracts different, distinguishable layers of a network to make networks agile and flexible. The goal of SDN is to improve network control by enabling enterprises and service providers to respond quickly to changing service requirements. SDN applications are programs that communicate behaviors and needed resources with the SDN controller via application programming interfaces (APIs). In addition, the applications can build an abstracted view of the network by collecting information from the controller for decision-making purposes. These applications may include networking management, analytics, or business applications used to run large data centers.

According, it is one object of the present disclosure to provide systems and methods for assigning an electric vehicle to a charging station which considers multi-objective functions such as maximizing requested energy and minimizing total response time for V2G and G2V based on an SDN architecture.

### SUMMARY

In an exemplary embodiment, a method for assigning an electric vehicle to a charging station by a fog and cloud-based charging service application is described. The method includes receiving, by a computing device of the fog and cloud-based charging service application, a request from an electric vehicle EVᵢ for a charging station assignment at a time Tᵢ, where i=1, 2, . . . , I. The method includes receiving, by the computing device, a position of the electric vehicle EVᵢ and a route of the electric vehicle EVᵢ. The method includes receiving, by the computing device, a present state of charge SOCᵢ^{prs}, a threshold state of charge SOCᵢ^{thr} and a maximum state of charge SOCᵢ^{max} of a battery of the electric vehicle EVᵢ. The method includes identifying, by the computing device, a number S of charging stations CSₛ, for s=1, 2, . . . , S, along the route of the electric vehicle EVᵢ. The method includes calculating, by the computing device, a travelling distance dimes of the electric vehicle EVᵢ to each charging station CSₛ. The method includes calculating, by the computing device, a travelling time T_{i→s}^{trv} for the electric vehicle EVᵢ to travel from the position to each charging station CSₛ. The method includes determining, by the computing device, a decrease SOC_{i→s}^{trv} in the present state of charge SOCᵢ^{prs} of the battery of the electric vehicle EVᵢ, based on the travelling distance d_{i→s} to each charging station CSₛ. The method includes calculating, by the computing device, an updated state of charge SOCᵢ^{upd} of the battery of the electric vehicle by subtracting the decrease in the present state of charge SOC_{i→s}^{trv} from the present state of charge SOCᵢ^{prs}. The method includes calculating, by the computing device, an amount of energy required Eᵢ^{req} to charge the battery of the electric vehicle EVᵢ at each charging station CSₛ based on a difference between a maximum state of charge SOCᵢ^{max} of the EVᵢ and the updated state of charge SOCᵢ^{upd} and multiplying the difference by an energy rating Eᵢ^{rt} of a battery of the electric vehicle EVᵢ. When the updated state of charge SOCᵢ^{upd} is greater than the threshold state of charge SOCᵢ^{thr}, the method includes calculating an amount of available energy Eᵢ^{avl} to discharge from the battery to the charging station CSₛ by multiplying a difference between the updated state of charge SOCᵢ^{upd} and the threshold state of charge SOCᵢ^{thr} by the energy rating Eᵢ^{rt}. The method further includes receiving, by the computing device, a vehicle-to-grid, V2G, energy credit and a grid-to-vehicle, G2V, energy cost from each charging station CSₛ. The method further includes receiving, by the computing device, from each charging station CSₛ a service charging time T_{i,s}^{ch} to charge the battery of the electric vehicle EVᵢ. The method further includes receiving, by the computing device, from each charging station CSₛ a service discharging time T_{i,s}^{dis} to charge the battery of the electric vehicle EVᵢ. The method further includes receiving, by the computing device, from each charging station a wait time T_{i,s}^{w} to access a charger. The method further includes calculating, by the computing device, a total charging response time T_{i,s}^{crs} for the battery of the electric vehicle EVᵢ to charge at each charging station, based on the travelling time T_{i→s}^{trv}, the service charging time T_{i,s}^{ch} and the wait time T_{i,s}^{w}. The method further includes calculating, by the computing device, a total discharging response time T_{i,s}^{drs} for the battery of the electric vehicle EVᵢ to discharge at each charging station, based on the travelling time T_{i→s}^{trv}, the service discharging time T_{i,s}^{dis} and the wait time T_{i,s}^{w}. The method further includes receiving, by the computing device, an energy available Eₛ^{avl} at each charging station CSₛ. The method further includes determining, by the computing device, an optimal charging station CSₒₚₜ, based at least on one of the amount of energy required Eᵢ^{req} eq to charge the battery of the electric vehicle EVᵢ at each charging station CSₛ and the amount of energy available Er to discharge the battery of the electric vehicle EVᵢ. further based on the V2G energy credit of each charging station CSₛ, the G2V energy cost of each charging station CSₛ, the amount of energy available Eₛ^{avl} at each charging station CSₛ, a minimum total charging response time T_{i,s}^{crs} at each charging station CSₛ, a minimum total discharging response time T_{i,s}^{drs} at each charging station CSₛ, a maximum amount of energy to be delivered to the battery of the electric vehicle EVᵢ and a maximum amount of energy to be delivered to each CSₛ. The method further includes assigning the optimal charging station CSₒₚₜ to the electric vehicle EVᵢ and transmitting, by the computing device, a route to the optimal charging station CSₒₚₜ to the electric vehicle EVᵢ. The method further includes receiving, by the computing device, a notice from the electric vehicle EVᵢ that it has arrived at the optimal charging station CSₒₚₜ. The method further includes transmitting, by the computing device, one of a charging command to the optimal charging station CSₒₚₜ to charge the battery of the electric vehicle EVᵢ to the maximum state of charge SOCᵢ^{max} and a discharging command to the optimal charging station CSₒₚₜ to discharge the battery of the EVᵢ to the threshold state of charge SOCᵢ^{thr}. The method further includes calculating, by the computing device, an updated energy Eᵢ^{upd} stored in the battery of the electric vehicle EVᵢ.

In another exemplary embodiment, a system for assigning an electric vehicle to a charging station is described. The system includes a software-defined networking (SDN) controller application stored in a cloud-based computing platform linked to a plurality of fog servers, wherein the SDN controller application is configured to manage network communications between the plurality of fog servers and the cloud-based computing platform, between the fog and a number S of charging stations CSₛ, where s=1, 2, . . . , S, and between the fog and a number I of electric vehicles EVᵢ, where I=1, 2, . . . , I; a computing device stored in the cloud platform, wherein the computing device includes a non-transitory computer readable medium having instructions stored therein which are configured to be executed by one or more processors; and a fog and cloud-based charging service application stored in the computing device, wherein the fog and cloud-based charging service application is executable by the one or more processors to: determine an optimal charging station CSₒₚₜ for each electric vehicle EVᵢ; assign the optimal charging station CSₒₚₜ to the electric vehicle EVᵢ; transmit a route to the optimal charging station CSₒₚₜ to the electric vehicle EVᵢ; receive a notice from the electric vehicle EVᵢ that it has arrived at the optimal charging station CSₒₚₜ; transmit one of a charging command to the optimal charging station CSₒₚₜ to charge a battery of the electric vehicle EVᵢ to a maximum state of charge SOCᵢ^{max} and a discharging command to the optimal charging station CSₒₚₜ to discharge the battery of the EVᵢ to a threshold state of charge SOCᵢ^{thr}; and calculate, by the computing device, an updated energy Eᵢ^{upd} stored in the battery of the electric vehicle EVᵢ. In another exemplary embodiment, a non-transitory computer readable medium having instructions stored therein that, when executed by one or more processors of a computing device of the fog and cloud-based charging service application, cause the one or more processors to perform a method for assigning an electric vehicle to a charging station is described. The method includes receiving a request from an electric vehicle EVᵢ for a charging station assignment at a time Tᵢ where i=1, 2, . . . , I. The method includes receiving a position of the electric vehicle EVᵢ and a route of the electric vehicle EVᵢ. The method includes receiving a present state of charge SOCᵢ^{prs}, a threshold state of charge SOCᵢ^{thr} and a maximum state of charge SOCᵢ^{max} of a battery of the electric vehicle EVᵢ. The method includes identifying a number S of charging stations CSₛ, for s=1, 2, . . . , S, along the route of the electric vehicle EVᵢ. The method includes calculating a travelling distance d_{i→s} of the electric vehicle EVᵢ to each charging station CSₛ. The method further includes calculating a travelling time T_{i→s}^{trv} for the electric vehicle EVᵢ to travel from the position to each charging station CSₛ. The method further includes determining a decrease SOC_{i→s}^{trv} in the present state of charge SOCᵢ^{prs} of the battery of the electric vehicle EVᵢ, based on the travelling distance d_{i→s} to each charging station CSₛ. The method further includes calculating an updated state of charge SOCᵢ^{upd} of the battery of the electric vehicle by subtracting the decrease in the present state of charge SOC_{i→s}^{trv} from the present state of charge SOCᵢ^{prs}. The method further includes calculating an amount of energy required Eᵢ^{req} to charge the battery of the electric vehicle EVᵢ at each charging station CSₛ based on a difference between a maximum state of charge SOCᵢ^{max} of the EVᵢ and the updated state of charge SOCᵢ^{upd} and multiplying the difference by an energy rating Eᵢ^{rt} of a battery of the electric vehicle EVᵢ. When the updated state of charge SOCᵢ^{upd} is greater than the threshold state of charge SOCᵢ^{thr}, the method includes calculating an amount of available energy Eᵢ^{avl} to discharge from the battery to the charging station CSₛ by multiplying a difference between the updated state of charge SOCᵢ^{upd} and the threshold state of charge SOCᵢ^{thr} by the energy rating Eᵢ^{rt}. The method includes receiving a vehicle-to-grid, V2G, energy credit and a grid-to-vehicle, G2V, energy cost from each charging station CSₛ. The method includes receiving from each charging station CSₛ a service charging time T_{i,s}^{ch} to charge the battery of the electric vehicle EVᵢ. The method includes receiving from each charging station CSₛ a service discharging time T_{i,s}^{dis} to charge the battery of the electric vehicle EVᵢ. The method includes receiving from each charging station a wait time T_{i,s}^{w} to access a charger. The method includes calculating a total charging response time T_{i,s}^{crs} for the battery of the electric vehicle EVᵢ to charge at each charging station, based on the travelling time T_{i→s}^{trv}, the service charging time T_{i,s}^{ch} and the wait time T_{i,s}^{w}. The method includes calculating a total discharging response time T_{i,s}^{drs} for the battery of the electric vehicle EVᵢ to discharge at each charging station, based on the travelling time T_{i→s}^{trv}, the service discharging time T_{i,s}^{dis} and the wait time T_{i,s}^{w}. The method includes receiving an energy available Eₛ^{avl} at each charging station CSₛ, determining an optimal charging station CSₒₚₜ based at least on one of the amount of energy required Eᵢ^{req} to charge the battery of the electric vehicle EVᵢ at each charging station CSₛ and the amount of energy available Eᵢ^{avl} to discharge the battery of the electric vehicle EVᵢ, further based on the V2G energy credit of each charging station CSₛ, the G2V energy cost of each charging station CSₛ, the amount of energy available Eₛ^{avl} at each charging station CSₛ, a minimum total response time T_{i,s}^{crs} at each charging station CSₛ, a maximum amount of energy to be delivered to the battery of the electric vehicle EVᵢ and a maximum amount of energy to be delivered to each CSₛ. The method includes assigning the optimal charging station CSₒₚₜ to the electric vehicle EVᵢ and transmitting a route to the optimal charging station CSₒₚₜ to the electric vehicle EVᵢ, receiving a notice from the electric vehicle EVᵢ that it has arrived at the optimal charging station CSₒₚₜ. The method includes transmitting one of a charging command to the optimal charging station CSₒₚₜ to charge the battery of the electric vehicle EVᵢ to the maximum state of charge SOCᵢ^{max} and a discharging command to the optimal charging station CSₒₚₜ to discharge the battery of the EVᵢ to the threshold state of charge SOCᵢ^{thr}. The method includes calculating an updated state of charge of the electric vehicle EVᵢ.

The foregoing general description of the illustrative embodiments and the following detailed description thereof are merely exemplary aspects of the teachings of this disclosure, and is not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is an exemplary schematic diagram of a system for assigning an electric vehicle (EV) to a charging station (CS), according to certain embodiments.

FIG. 2 is a communication network diagram of a software-defined networking (SDN) controller application, according to certain embodiments.

FIG. 3 is a block distribution of charging stations in a city, according to certain embodiments.

FIG. 4 is a graph representing discharging time for various EVs at CSₛ, according to certain embodiments.

FIG. 5 is a graph representing assigning various EVs to the optimal CS using the fog and cloud-based charging service application, according to certain embodiments.

FIG. 6 is a graph representing the updated rated energy of the EVs after using charging service, according to certain embodiments.

FIG. 7 is a graph representing the updated rated energy of the CS for the fog and cloud-based charging service application, according to certain embodiments.

FIG. 8 is a graph representing the updated rated energy of the EV after charging from a mobile charging station (MCS), according to certain embodiments.

FIG. 9 is a graph representing assigning various EVs to a CS using the discharging service, according to certain embodiments.

FIG. 10 is a graph representing updated rated energy of various EVs after using the discharging service, according to certain embodiments.

FIG. 11 is a graph representing the updated rated energy of the CS after the discharging service, according to certain embodiments.

FIG. 12 is a graph representing a satisfaction factor for charging EVs, according to certain embodiments.

FIG. 13 is a graph representing a satisfaction factor for discharging EVs, according to certain embodiments.

FIG. 14 is an illustration of a non-limiting example of details of computing hardware used in the computing system, according to certain embodiments.

FIG. 15 is an exemplary schematic diagram of a data processing system used within the computing system, according to certain embodiments.

FIG. 16 is an exemplary schematic diagram of a processor used with the computing system, according to certain embodiments.

FIG. 17 is an illustration of a non-limiting example of distributed components which may share processing with the controller, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

Aspects of this disclosure are directed to a system and methods for assigning an electric vehicle to a charging station by a fog and cloud-based charging service application. Electric vehicles (EVs) are becoming available in the automobile market. One of the major challenges in supporting EVs is in allocating each EV to an optimal charging station (CS). The present disclosure describes calculations which assign EVs to optimal charging stations based on the software-defined networking (SDN) communication framework. The objective of the present disclosure is to allocate each EV to an optimal CS while maximizing trading energy and minimizing total response time. Therefore, aspects of the present disclosure consider the travelling distance of the EV, a charging (vehicle-to-grid, V2G) energy cost and a discharging (grid-to-vehicle, G2V) energy price, total response time starting from the request time ending with the time the EV leaves the charging station, and an energy cost of the CS.

Aspects of the present disclosure describe an emergency model for a situation in which the EV does not have sufficient energy to travel to nearest CS. The emergency model is based on travelling salesperson problem (TSP) to find an optimal route for mobile charging station (MCS).

Non-limiting definitions of one or more terms used in the present disclosure are provided below.

The term “software-defined networking (SDN)” is a communications architecture in which a centralized controller controls the forwarding behavior of a set of distributed switches. SDN is designed to make a network more flexible and easier to manage. SDN centralizes management by abstracting the control plane from the data forwarding function in discrete networking devices.

The term “SDN controller” is a core element of an SDN architecture, which enables centralized management and control, automation, and policy enforcement across physical and virtual network environments.

The term “fog computing” refers to a decentralized computing infrastructure or process in which computing resources are located between a data source and a cloud or any other data center. Fog computing is a paradigm that provides services to user requests at edge networks. Devices in fog layer usually perform operations related to networking, such as routers, gateways, bridges, and hubs.

The term “cloud computing” refers to the delivery of different services over the Internet. The cloud computing resources include tools and applications, including data storage, servers, databases, networking, and software.

The term “state of charge (SoC)” refers to a measurement of an amount of energy available in a battery at a specific point in time expressed as a percentage. For example, the SoC reading for the battery might read 95% full or 10% full. The SoC provides information related to how much longer the battery can perform before it needs to be charged or replaced. The battery of an electric vehicle should be optimized to increase the life of the battery.

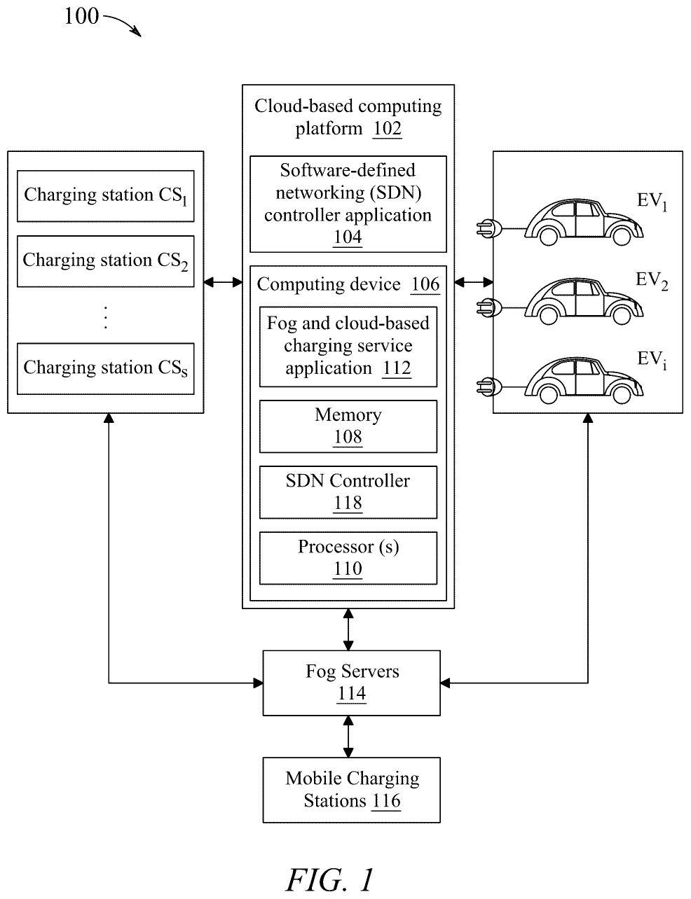

FIG. 1 is an exemplary schematic diagram of a system 100 for assigning an electric vehicle (EV) to a charging station (CS). As shown in FIG.1, the system 100 includes a cloud-based computing platform 102, a plurality of fog servers 114, a number of electric vehicles (EV₁ to EVᵢ), where i=1, 2, . . . , I, and a number S of charging stations CSₛ, where s=1, 2, . . . , S. I is a finite number determined by the system as being the total number, I, of electric vehicles EVᵢ communicating with the cloud-based computing platform 102 and the plurality of fog servers 114 located on a route of a specific EVᵢ within a specified travelling distance of the EVᵢ. The specified travelling distance is determined for each EVᵢ by the fog and cloud-based charging service application and is different for each EVᵢ and depends on the location of the EVᵢ and the state of charge, SOC of the EVᵢ. Similarly, S is a finite number determined by the cloud-based computing platform 102 and depends on the number of charging stations located within the specified travelling distance. A maximum travelling distance may be set by the EVᵢ when registering with the fog and cloud-based charging service application. For example, a user of the EVᵢ may prefer that travel to a charging station is no greater than a distance of 10 km. The fog and cloud-based charging service application may be configured to locate all the charging stations that lie within a circle surrounding the EVᵢ with a radius of 10 km. Further, the fog and cloud-based charging service application is configured to receive the route of the electric vehicle. The fog and cloud-based charging service application is configured to consider only those charging stations that are enroute and lie within the distance of 10 km of the EVᵢ. In this way, the fog and cloud-based charging service application is configured to determine the number, S, of charging stations and find an optimal charging station CSₒₚₜ by taking the specified travelling distance as a constraint.

The EV is configured to wirelessly receive electric power from the charging station (CS). In an aspect, the EVs are electric land vehicles. Each of the electric vehicles, EVᵢ, is configured to communicate with the cloud-based computing platform 102 via one or more of the plurality of fog servers 114. In an aspect, the information may include, inter alia, a required amount of energy, a residual amount of energy, a travel route of the EV, and position data of the EV. The position data of the EV may be location coordinates generated by a navigation system, a global positioning system (GPS), a Galileo system and/or a global navigation satellite system (GLONASS).

The CS includes electric vehicle supply equipment (EVSE) configured to supply electrical power for charging plug-in electric vehicles (PEVs). Each CSₛ is configured to send and/or receive data from the cloud-based computing platform 102 via one or more of the plurality of fog servers 114. The data may include a charging rate of the electrical energy, a price of selling, by the EV, electrical energy to the CS, a cost of charging the EV with the electrical energy, the number of electric vehicles that can be served at one time, and a location of the charging station CSₛ. In an aspect, when the electric vehicle EVᵢ reaches the CSₛ, the electric vehicle EVᵢ and the charging station CSₛ are configured to communicate with each other through wireless communication. The wireless communication may include but is not limited to one or any combination of Bluetooth, Wireless Fidelity (WiFi), ZigBee, a radio frequency identification (RFID) technology, a long range (Lora) wireless technology, and a Near Field Communication (NFC) technology.

In an aspect of the present disclosure, the electric vehicles EVᵢ and the charging stations CSₛ include communications circuitry that transmit/receive wireless signals to/from at least one of the fog servers 114. In an example, the wireless signal may include an audio call signal, a video (telephony) call signal, or various formats of data according to transmission/reception of text and/or multimedia messages.

The electric vehicles, EVᵢ, and the charging stations, CSₛ, support wireless Internet access. Examples of such wireless Internet access may include a wireless local area network (WLAN) (Wi-Fi), a wireless broadband (WiBro) network, worldwide interoperability for microwave access (WiMAX), a high-speed downlink packet access (HSDPA), and the like.

The cloud-based computing platform 102 is configured to store a SDN controller application 104 and a computing device 106. In an aspect, the cloud-based computing platform 102 is configured to provide one or more of three services: software-as-a-service (SaaS), infrastructure-as-a-service (IaaS), and platform-as-a-service (PaaS). In an example, the cloud-based computing platform 102 includes a plurality of computer resources. The computing resource may be, for example, a virtual machine, cloud-based application, or data for a cloud-based application.

In an example, the cloud-based computing platform 102 may include a network interface that allows a user of the EV and/or the CS to establish a communicative connection to the cloud-based computing platform 102 over a network such as the Internet or any type of network described herein. The cloud-based computing platform 102 includes an application platform that provides access to various applications and database systems provided by the application platform via a cloud-based user interface. In some examples, the cloud-based computing platform 102 is a hybrid cloud-based computing platform, a public cloud-based computing platform, or a private cloud-based computing platform.

As shown in FIG. 1, the cloud-based computing platform 102 includes the SDN controller application 104, and a computing device 106.

From a networking aspect, the SDN controller application 104 is coupled to the plurality of fog servers 114. The SDN controller application 104 is configured to manage network communications between the plurality of fog servers 114 and the cloud-based computing platform 102. The SDN controller application 104 manages network communications between the plurality of fog servers 114 and the charging stations CSₛ. Also, the SDN controller application 104 manages network communications between the plurality of fog servers 114 and each electric vehicle EVᵢ.

In an aspect, each fog server 114 includes a fog server memory (not shown in the figures) and at least one processor. The fog servers 114 are located in areas proximate to the client devices (electric vehicles EVᵢ, and charging stations CSₛ). The fog servers 114 support delivery of computing services to all devices that reside at the edge of the network, instead of the cloud-based computing platform 102. For example, the fog servers 114 may receive service requests directly from the electric vehicles EVᵢ and the charging stations CSₛ or via a gateway or other networking devices such as switches, routers, and similar. The fog servers 114 are configured to execute services related to data processing, networking, storage, and analytics. The fog servers 114 receive service requests from the client devices and execute (e.g., perform functions related to) the service requests in a manner that is fast and efficient. For example, the fog servers 114 may include hardware, software, and/or firmware that may be configured to perform designated services. The fog servers 114 are configured to provide a dense geographical distribution, and support for mobility. The fog servers 114 support heterogeneity and provide low latency, location awareness, and improved quality of service (QoS) for streaming and real-time applications (e.g., in industrial automation, transportation, and sensor and actuator networks). In an aspect, the fog servers 114 are connected to a plurality of fog devices, that may include end-user devices, access points, edge routers, and switches, amongst others, spanning multiple management domains.

The computing device 106 includes a non-transitory computer-readable medium 108 (hereinafter, the memory 108), one or more processors 110, and a fog and cloud-based charging service application 112. The computing device 106 broadly refers to any electronic, electro-optical, and/or mechanical device, or system of multiple physically separate or physically joined such devices, configured to process and manipulate information, such as data packets. Non-limiting examples of the computing device include one or more personal computers (e.g., desktop or laptop), servers, smartphones, personal digital assistants (PDAs), television set-top boxes, and/or a system of these in any combination. In addition, the computing device 106 may be physically located completely in one location or may be distributed amongst a plurality of locations (i.e., may implement distributive computing).

In an aspect, the memory 108 is configured to store the fog and cloud-based charging service application 112. In an aspect, the memory 108 is configured to store data for short periods or in the presence of power such as a memory device or Random Access Memory (RAM). In one example, the non-transitory computer-readable medium/memory 108 may store computer-readable instructions (e.g., software) and/or computer-readable data (that is, information that may or may not be executable). The memory 108 is configured to store a set of rules for processing the received requests/data. In some examples, the memory 108 may include any computer-readable storage medium known in the art including, for example, volatile memory, such as Static Random Access Memory (SRAM) and Dynamic Random Access Memory (DRAM), and/or a non-volatile memory, such as Read Only Memory (ROM), erasable programmable ROM, flash memories, hard disks, optical disks, and magnetic tapes.

The one or more processors 110 cooperate with the memory 108 to receive and execute the instructions for processing the received requests and data. The one or more processors 110 may be implemented as one or more microprocessors, microcomputers, digital signal processors, central processing units, state machines, logic circuitries, and/or any devices that manipulate signals based on program instructions.

The system 100 is configured to register each electric vehicle EVᵢ, and each charging station CSₛ with the fog and cloud-based charging service application 112. The fog and cloud-based charging service application 112 is executable by the one or more processors 110 to determine an optimal charging station CSₒₚₜ for each electric vehicle EVᵢ. The computing device 106 (one or more processors), by executing the fog and cloud-based charging service application 112 transmits a route to the optimal charging station CSₒₚₜ to the electric vehicle EVᵢ. The fog and cloud-based charging service application 112 receives a notice from the electric vehicle EVᵢ when the electric vehicle EVᵢ arrives at the optimal charging station CSₒₚₜ. On receiving the notice from the electric vehicle EVᵢ, the fog and cloud-based charging service application 112 transmits one of a charging command to the optimal charging station CSₒₚₜ to charge a battery of the electric vehicle EVᵢ to a maximum state of charge SOCᵢ^{max} and a discharging command to the optimal charging station CSₒₚₜ to discharge the battery of the EVᵢ to a threshold state of charge SOCᵢ^{thr}. Further, the computing device 106 is configured to calculate an updated energy, Eᵢ^{upd}, stored in the battery of the electric vehicle EVᵢ.

In an operative aspect, the fog and cloud-based charging service application 112 is executable by the one or more processors 110 to receive a request from the electric vehicle EVᵢ for a charging station assignment at a time Tᵢ, where i=1, 2, . . . , I. After receiving the request from the electric vehicle EVᵢ, the fog and cloud-based charging service application 112 receives a position of the electric vehicle EVᵢ and a route of the electric vehicle EVᵢ. The fog and cloud-based charging service application 112 also receives a present state of charge, SOCᵢ^{prs}, the threshold state of charge, SOCᵢ^{thr}, and the maximum state of charge, SOCᵢ^{max}, of a battery of the electric vehicle, EVᵢ. Based on the received information from the electric vehicle EVᵢ, the fog and cloud-based charging service application 112 identifies a number S of charging stations CSₛ, for s=1, 2, . . . , S, along the route of the electric vehicle EVᵢ. After identifying the number S of charging stations CSₛ, the fog and cloud-based charging service application 112 calculates a travelling distance d_{i→s} of the electric vehicle EVᵢ to each charging station CSₛ and calculates a travelling time T_{i→s}^{trv} for the electric vehicle EVᵢ to travel from the position to each charging station CSₛ. The fog and cloud-based charging service application 112 determines a decrease SOC_{i→s}^{trv} in the present state of charge SOCᵢ^{prs} of the battery of the electric vehicle EVᵢ, based on the travelling distance d_{i→s} to each charging station CSₛ. The fog and cloud-based charging service application 112 calculates an updated state of charge SOCᵢ^{upd} of the battery of the electric vehicle by subtracting the decrease in the present state of charge SOC_{i→s}^{trv} from the present state of charge SOCᵢ^{prs}. Based on the determined decreased SOC_{i→s}^{trv} in the present state of charge SOCᵢ^{prs} of the battery of the electric vehicle EVᵢ, the fog and cloud-based charging service application 112 calculates the energy required Eᵢ^{req} to charge the battery of the electric vehicle EVᵢ at each charging station CSₛ based on a difference between a maximum state of charge SOCᵢ^{max} of the EVᵢ and the updated state of charge SOCᵢ^{upd} and multiplies the difference by an energy rating Eᵢ^{rt} of a battery of the electric vehicle EVᵢ. When the updated state of charge SOCᵢ^{upd} is greater than the threshold state of charge SOCᵢ^{thr}, the fog and cloud-based charging service application 112 calculates an amount of available energy Eᵢ^{avl} to discharge from the battery to the charging station CSₛ by multiplying a difference between the updated state of charge SOCᵢ^{upd} and the threshold state of charge SOCᵢ^{thr} by the energy rating Eᵢ^{rt}.

The fog and cloud-based charging service application 112 receives a V2G energy credit and a G2V energy cost from each charging station CSₛ. Also, the fog and cloud-based charging service application 112 receives a service charging time T_{i,s}^{ch} from each charging station CSₛ to charge the battery of the electric vehicle EVᵢ and a service discharging time T_{i,s}^{dis} from each charging station CSₛ to charge the battery of the electric vehicle EVᵢ.

The fog and cloud-based charging service application 112 receives a wait time T_{i,s}^{w} to access a charger from each CS. Based on the travelling time T_{i→s}^{trv}, the service charging time T_{i,s}^{ch} and the wait time T_{i,s}^{w}, the fog and cloud-based charging service application 112 calculates a total charging response time T_{i,s}^{crs} for the battery of the electric vehicle EVᵢ to one of charge and discharge at each charging station. Further, based on the travelling time T_{i→s}^{trv}, the service discharging time T_{i,s}^{dis} and the wait time T_{i,s}^{w}, the fog and cloud-based charging service application 112 calculates a total discharging response time T_{i,s}^{drs} for the battery of the electric vehicle EVᵢ to discharge at each charging station. The fog and cloud-based charging service application 112 receives the energy available Eₛ^{avl} at each charging station CSₛ. The fog and cloud-based charging service application 112 determines the optimal charging station CSₒₚₜ based at least on one of factors. The factors may be listed as: an amount of energy required Eᵢ^{req} to charge the battery of the electric vehicle EVᵢ at each charging station CSₛ and an amount of energy available Eᵢ^{avl} to discharge the battery of the electric vehicle EVᵢ, the V2G energy credit of each charging station CSₛ, the G2V energy cost of each charging station CSₛ, the amount of energy available Eₛ^{avl} at each charging station CSₛ, a minimum total charging response time T_{i,s}^{crs} at each charging station CSₛ, a minimum total discharging response time T_{i,s}^{drs} at each charging station CSₛ, a maximum amount of energy to be delivered to the battery of the electric vehicle EVᵢ and a maximum amount of energy to be delivered to each CSₛ.

The fog and cloud-based charging service application 112 also calculates a satisfaction level of the EVᵢ after one of charging and discharging based on the updated state of charge Eᵢ^{upd} and the total response time T_{i,s}^{crs} at the optimal charging station CSₒₚₜ. In an example, the optimal charging station CSₒₚₜ is a charging station that stores a number of pre-requisite conditions. There are S charging stations, but only one charging station is determined to be the optimal charging station CSₒₚₜ. In such a scenario, all the available charging stations are optimized and depending on the number of pre-requisite conditions, the system 100 provides the optimal charging station CSₒₚₜ. In an example, the fog and cloud-based charging service application 112 may be configured to assign an optimization value to each of the charging stations and create a list based upon the assigned optimization values. In an example, the fog and cloud-based charging service application 112 may be configured to reserve top 3 (three) charging stations corresponding to each EVᵢ. In such way, a list may be created for each of the electric vehicles EVᵢ and all the charging stations are fully optimized.

In one instance, when the fog and cloud-based charging service application 112 determines that the decrease (depletion) SOC_{i→S}^{trv} in the present state of charge SOCᵢ^{prs} of the battery of the electric vehicle EVᵢ, is greater than or equal to the threshold state of charge SOCᵢ^{thr}, the fog and cloud-based charging service application 112 determines that an optimal charging station CSₒₚₜ cannot be determined in this instance. In such instance, the fog and cloud-based charging service application 112 searches for a plurality of mobile charging stations 116 within the specified travelling distance of the electric vehicle EVᵢ and determines a location of each of the plurality of mobile charging stations 116 within the specified travelling distance.

In an example, the fog and cloud-based charging service application 112 may be configured to store the coordinates of the charging stations. When a the mobile charging station is needed, the fog and cloud-based charging service application 112 stores the updated locations of the mobile charging stations. In some examples, the fog and cloud-based charging service application 112 may be configured to request the current location the electric vehicle EVᵢ from the user or fetch the current location in communication with a location determining system (installed in user device, electric vehicle). In an example, the location determining system is one of a Global Positioning System (“GPS”), a aGalileo system, GLONASS system, a Quasi-Zenith Satellite System (“QZSS”), a Beidou satellite system, a Compass satellite system, and combinations thereof. By comparing the stored co-ordinates of the mobile charging stations and the present location of the electric vehicle EVᵢ, the fog and cloud-based charging service application 112 is configured to determine a travel distance from each mobile charging station to the electric vehicle EVᵢ and to identify the mobile charging station 116 which has the shortest travel distance to the electric vehicle EVᵢ. After identifying the mobile charging station 116 having the shortest travel distance to the electric vehicle EVᵢ, the fog and cloud-based charging service application 112 initiates a request that the mobile charging station 116 travel to the electric vehicle EVᵢ and deliver the amount of energy needed to increase the present state of charge SOCᵢ^{prs} of the battery of the electric vehicle EVᵢ to the maximum state of charge SOCᵢ^{max}.

In another instance, when the amount of energy available Eₛ^{avl} at each charging station CSₛ is less than the amount of energy needed to increase the present state of charge SOCᵢ^{prs} of the battery of the electric vehicle EVᵢ to the maximum state of charge SOCᵢ^{max}, the fog and cloud-based charging service application 112 is configured to identify a charging station which has the minimum total response time T_{i.S}^{crs} of the number S of charging stations CSₛ. The fog and cloud-based charging service application 112 selects the optimal charging station CSₒₚₜ based at least on the charging station which has at least the minimum total response time T_{i,S}^{crs}. The fog and cloud-based charging service application 112 transmits a command to the optimal charging station CSₒₚₜ which has at least the minimum total response time T_{i,s}^{crs} to charge the battery of the electric vehicle EVᵢ with energy sourced from a utility grid. In an example, the total response time is calculated by considering various factors such as time slot in which EVᵢ arrives the CSₛ, travelling time for EVᵢ to travel from current location to the CS location, service charging time for EVᵢ at CSₛ, and waiting time for EVᵢ at CSₛ.

In an aspect, the fog and cloud-based charging service application 112 receives a rated energy capacity of each charging station CSₛ and a total number of electric vehicles charging at each charging station CSₛ, and estimates, whether the rated energy capacity of each charging station CSₛ is sufficient to provide the required energy to charge the battery of the electric vehicle to the maximum state of charge SOCᵢ^{max}.

When the updated state of charge SOCᵢ^{upd} is greater than the threshold state of charge SOCᵢ^{thr}, the fog and cloud-based charging service application 112 calculates a credit for the electric vehicle to discharge its energy to the threshold state of charge SOCᵢ^{thr} at the each charging station CSₛ and determines which charging station CSₛ offers the highest energy credit.

In some aspects, when the updated state of charge SOCᵢ^{upd} is less than or equal to the threshold state of charge SOCᵢ^{thr}, the fog and cloud-based charging service application 112 calculates an energy cost to charge the battery of the electric vehicle EVᵢ to its maximum state of charge SOCᵢ^{max} at each charging station CSₛ, determines which charging station has the lowest energy cost, and determines the optimal charging station CSₒₚₜ based at least on one of the highest energy credit and the lowest energy cost.

In an aspect, the fog and cloud-based charging service application 112 calculates a satisfaction level of the EVᵢ after one of charging and discharging based on the updated state of charge Eᵢ^{upd} and the total response time T_{i,s}^{crs} at the optimal charging station CSₒₚₜ.

The fog and cloud-based charging service application 112 receives a first satisfaction level weight α and a second satisfaction level weight β and generates a charging energy factor by dividing the updated state of charge SOCᵢ^{upd} by the energy rating Eᵢ^{rt}. Further, the fog and cloud-based charging service application 112 generates a charging time factor by dividing a time slot available T_{i,s}^{avl} at the optimal CSₒₚₜ, by the total response time T_{i,s}^{crs}. Also, the fog and cloud-based charging service application 112 multiplies the charging energy factor by the first satisfaction level weight α and generating a weighted charging energy factor and multiplies the charging time factor by the second satisfaction level weight a and generating a weighted charging time factor. The fog and cloud-based charging service application 112 calculates a charging satisfaction level Sᵢ^{ch} of the EVᵢ by adding the weighted charging energy factor to the weighted charging time factor.

The fog and cloud-based charging service application 112 estimates an estimated charging satisfaction level S_{i,est}^{ch} of the EVᵢ at each CSₛ, and calculates the optimal charging station CSₛ based in part on the estimated charging satisfaction level S_{i,est}^{ch} of the EVᵢ.

The fog and cloud-based charging service application 112 receives the first satisfaction level weight α and the second satisfaction level weight β, and generates a discharging energy factor by dividing the energy discharged E_{i→s}^{giv} by the electric vehicle EVᵢ to the optimal charging station CSₛ by the amount of available energy Eᵢ^{avl} in the battery of the electric vehicle EVᵢ. Also, the fog and cloud-based charging service application 112 generates a discharging time factor by dividing a time slot available T_{i,s}^{avl} at the optimal charging station CSₒₚₜ, by the total discharging response time T_{i,s}^{drs} and multiplies the discharging energy factor by the first satisfaction level weight α and generating a weighted discharging energy factor. Also, the fog and cloud-based charging service application 112 multiplies the discharging time factor by the second satisfaction level weight a and generates a weighted discharging time factor and calculates a discharging satisfaction level Sᵢ^{dis} of the EVᵢ by adding the weighted discharging energy factor to the weighted discharging time factor. The fog and cloud-based charging service application 112 estimates an estimated discharging satisfaction level S_{i,est}^{dis} of the EVᵢ at each CSₛ, and calculates the optimal charging station CSₛ based in part on the estimated discharging satisfaction level S_{i,est}^{dis} of the EVᵢ.

In an aspect, the energy available at each charging station CSₛ is stored in a charging station battery, which is recharged by energy generated by a plurality of photovoltaic panels and/or by energy received from discharging electric vehicles.

The fog and cloud-based charging service application 112 is configured to apply the following constraints in determining the optimal charging station CSₒₚₜ when charging the battery of the electric vehicle EVᵢ: the electric vehicle EVᵢ is assigned to only one CSₛ, a total energy transferred to the batteries of all electric vehicles assigned to a charging station CSₛ is less than or equal to the available energy Eₛ^{avl} of the CSₛ, the electric vehicle EVᵢ must be able to pay a price for charging its battery, the updated energy Eᵢ^{upd} stored in the battery of the electric vehicle EVᵢ after charging equals the present state of charge SOCᵢ^{prs} multiplied by the energy rating Eᵢ^{rt} of the battery of the electric vehicle EVᵢ, plus the energy delivered by the optimal CSₒₚₜ to the battery of the electric vehicle EVᵢ minus the decrease in the present state of charge SOC_{i→s}^{trv} multiplied by the energy rating Erof the battery of the electric vehicle EVᵢ, the updated energy Eₛ^{upd} of the optimal charging station CSₒₚₜ equals the energy available Eₛ^{avl} at the optimal charging station minus an amount of energy delivered E_{s→i}^{giv} by the charging station to the battery of the electric vehicle EVᵢ, the updated energy Eᵢ^{upd} stored in the battery of the electric vehicle EVᵢ after charging must be less than a battery capacity Eᵢ^{rat} of the battery of the electric vehicle EVᵢ, the amount of energy delivered E_{s→i}^{giv} to the battery of the electric vehicle EVᵢ should be greater than the decrease in the present state of charge SOC_{i→s}^{trv} multiplied by the energy rating Eᵢ^{rt} of the battery of the electric vehicle EVt, the total charging response time T_{i,s}^{crs} must be less than or equal to a maximum estimated charging response time, a total number of electric vehicles charging at a charging station CSₛ must be less than or equal to a total number of chargers at the charging station CSₛ, the electric vehicle is one of assigned to an optimal charging station CSₒₚₜ and not assigned to a charging station CSₛ, and the total charging response time T_{i,s}^{crs}, the amount of energy delivered E_{s→i}^{giv} to the battery of the electric vehicle EVᵢ and the updated energy Eᵢ^{upd} are greater than or equal to zero.

The fog and cloud-based charging service application 112 is configured to apply the following constraints in determining the optimal charging station CSₒₚₜ when discharging the battery of the electric vehicle EVᵢ: the electric vehicle EVᵢ is assigned to only one CSₛ, each charging station CSₛ should be able to pay a price for receiving energy from the battery of the electric vehicle EVᵢ, the updated energy Eᵢ^{upd} stored in the battery of the electric vehicle EVᵢ after discharging equals the present state of charge SOCᵢ^{prs} multiplied by the energy rating Eᵢ^{rt} of the battery of the electric vehicle EVᵢ, minus the energy delivered to the optimal CSₒₚₜ by the battery of the electric vehicle EVᵢ, minus the decrease in the present state of charge SOC_{i→s}^{trv} multiplied by the energy rating Eᵢ^{rt} of the battery of the electric vehicle EVᵢ, the updated energy Eₛ^{upd} of the charging station CSₛ must equal an energy present Eₛ^{prs} at the charging station plus an amount of energy generated Eₛ^{ren} by photovoltaic panels connected to the battery of the charging station, plus an amount of energy delivered E_{s→i}^{giv} by the charging station to the battery of the electric vehicle EVᵢ, the updated energy Eₛ^{upd} of the charging station CSₛ should be less than or equal to a rated pool capacity Eₛ^{rat} of the charging station CSₛ, the total discharging response time T_{i,s}^{drs} should be less than or equal to a maximum estimated discharging response time, a total number of electric vehicles discharging at a charging station CSₛ should be less than or equal to a total number of chargers at the charging station CSₛ, the electric vehicle is one of assigned to an optimal charging station CSₒₚₜ and not assigned to a charging station CSₛ, and the total charging response time, T_{i,s}^{crs}, the amount of energy delivered, E_{s→i}^{giv}, to the battery of the electric vehicle EVᵢ and the updated energy, Eᵢ^{upd}, are greater than zero. For example, the fog and cloud-based charging service application 112 may be configured to assign a weight to several factors corresponding to the CS during discharging the battery of the electric vehicle EVᵢ. In an aspect, the factors may include the electric vehicle EVᵢ assigned to only one CSₛ, price payable by each charging station CSₛ for receiving energy from the battery of the electric vehicle EVᵢ, the updated energy Eᵢ^{upd} stored in the battery of the electric vehicle EVᵢ after discharging the battery, the energy delivered to the optimal CSₒₚₜ by the battery of the electric vehicle EVᵢ, the decrease in the present state of charge SOC_{i→s}^{trv}, the updated energy Eₛ^{upd} of the charging station CSₛ, an amount of energy delivered E_{s→i}^{giv} by the charging station to the battery of the electric vehicle EVᵢ, the updated energy Eₛ^{upd} of the charging station CSₛ, the total discharging response time T_{i,s}^{drs}, a total number of electric vehicles discharging at a charging station CSₛ, and the total charging response time, T_{i,s}^{crs}. The fog and cloud-based charging service application 112 may be configured to calculate a total of weight assigned to each CS and based upon the total weight choose the optimal charging station CSₒₚₜ.

In an aspect, the computing device 106 includes a SDN controller 118 that is configured to monitor network traffic and/or state(s) of the various elements of the system 100. The SDN controller 118 may execute on cloud-based computing platform 102. In an example, the SDN controller 118 has a centralized global view of the network and is configured to program the network devices dynamically based on network traffic, state(s) of the various elements and/or policies set by, e.g., a network administrator. The SDN controller 118 is configured to execute the SDN controller application 104 on the cloud-based computing platform 102.

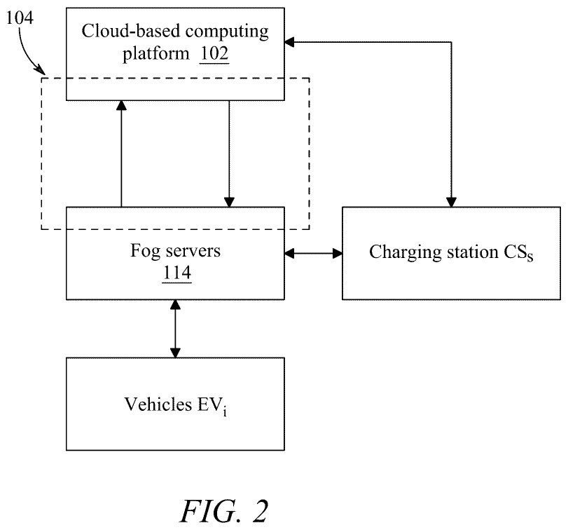

FIG. 2 is a communication network diagram of the fog and cloud-based charging service application 112 and the SDN controller application 104.

The cloud-based computing platform 102 is configured to provide an application platform that assigns the electric vehicle to the charging station. The cloud-based computing platform 102 may include various components and one or more networks (e.g., computing or communication networks). In some aspects, the cloud-based computing platform 102 may be multi-dimensional that can span across multiple dimensions. For example, the cloud-based computing platform 102 may be a multi-cloud or multi-operating system architecture, can employ a multi-dimensional deployment model (e.g., traditional computing infrastructure, private cloud, or public cloud). The cloud-based computing platform 102 is configured to communicate to the plurality of fog servers 114 using the SDN controller application 104.

The plurality of fog servers 114 are configured to receive data from the electric vehicles EVᵢ and charging stations CSₛ and process the received data locally. With the evolution of the Internet of Things (IoT), more devices are being added to communications networks. Each device is wirelessly connected for data transmission and reception. The fog servers 114 provide fast response time, reducing network latency and traffic, and supporting backbone bandwidth savings in order to improve quality of service (QoS). In an aspect, the fog servers 114 are used to transmit relevant data to the cloud-based computing platform 102.

The SDN controller application 104 manages network communications between the fog servers 114 and the cloud-based computing platform 102, between the fog servers 114 and the charging stations, CS, and between the fog servers 114 and the electric vehicles, EV. The SDN controller application 104 is configured to deliver a centralized, and programmable network.

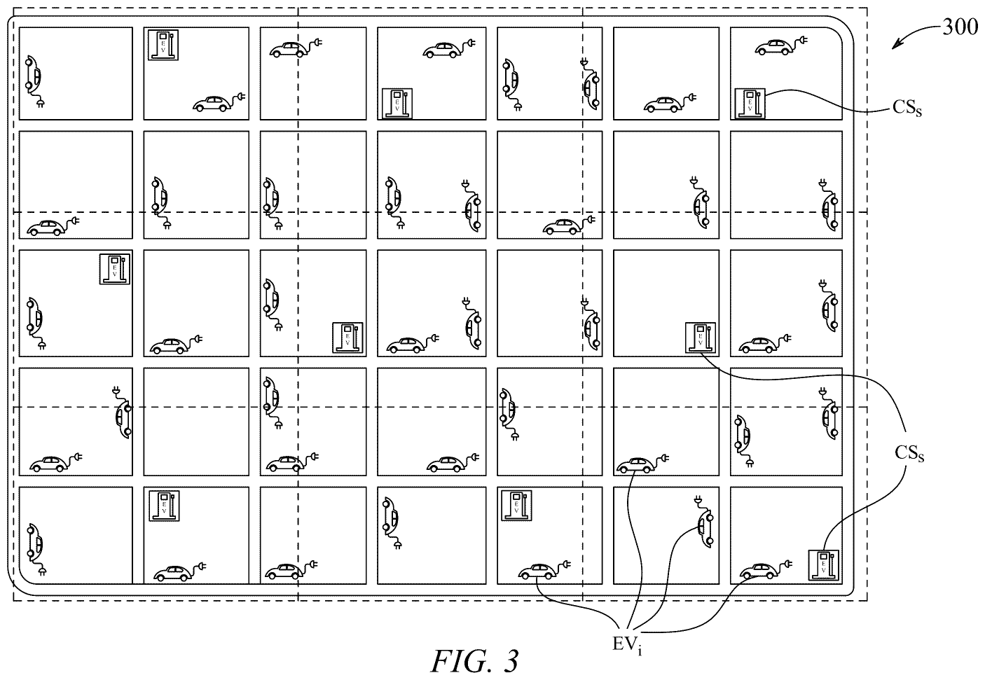

FIG. 3 depicts a block distribution of charging stations in a city 300. In an example, a city is divided into a number of city blocks. For example, the city blocks are the space for buildings within the street pattern of a city and form the basic unit of a city's urban map. Every city block has a number of CSs and EVs. As the distance from an EV location to a CS location is the primary factor for selecting the CS, each EV may prefer to exchange energy with the nearest CS in the same block. For example, the CSₛ located in the same block as the EVi may be assigned a higher weight during allocation of CSₛ to the EVs. In an example, the weight assigned to the charging station may be directly proportional to the travel distance from the EVs. But if the CS energy price or total response time in a different block (not the same EV block) is optimum then the EV may travel to that block if the EV is willing to travel and charge/discharge. During an emergency situation when the EVᵢ cannot travel to the CS because its current state of charge (SOC) is lower than the required SOC to travel, it may request a mobile charging station (MCS). The MCS is assumed to have enough energy to travel and supply the requested demand for every EV in an emergency case. The MCS is configured to follow the optimal route generated from the emergency model to serve the EVᵢ.

In an example, the distance from EVᵢ location to CSₛ location is calculated by the rectilinear distance, which is a distance along paths that are perpendicular to each another. Let (xᵢ, yᵢ) be the location coordination of EVᵢ and (xₛ, yₛ) be the location coordination of CSₛ. Then the distance is given by:

d_{i→s}=|xₛ−xᵢ|+|yₛ−yᵢ|. (1)

The system 100 is configured to operate into three different modes referred to as an Energy Charging Time Model (ECTM), an Energy Discharging Time Model (EDTM) and an Emergency Model (EM).

In the ECTM model, the EVᵢ submits a request for charge energy from the CSₛ, with the goal of achieving the maximum energy level. Every EV includes a charging battery with different rated capacities. The required SOC for EVᵢ to achieve the maximum level is:

SOCᵢ^{req}=SOCᵢ^{max}−SOCᵢ^{prs} ,(2)

where the present SOC for EVᵢ is SOCᵢ^{prs} and SOCᵢ^{max} is the maximum level of the EVᵢ SOC. The required energy for EVᵢ to charge to the maximum level is:

Eᵢ^{req}=SOCᵢ^{req}×Eᵢ^{rt} .(3)

where Eᵢ^{rt} is the rated energy capacity of EVᵢ battery (maximum capacity of i^{th} EV's battery).

Energy available at CSₛ SOCₛ^{avl} is equal to the present SOC at CSₛ SOCₛ^{prs} minus the SOC threshold SOCₛ^{thr}:

SOCₛ^{avl}=SOCₛ^{prs}−SOCₛ^{thr} .(4)

The energy available at CSₛ Eₛ^{avl} is:

Eₛ^{avl}=SOCₛ^{avl}×Eₛ^{rt} ,(5)

where Eₛ^{rt} is the rated battery pool capacity of the CSₛ.

To be certain that CSₛ can meet the requested EV energy, the present SOC at CSₛ SOCₛ^{prs} should be greater than the threshold SOC, SOCₛ^{thr}.

SOCₛ^{prs}>SOCₛ^{thr} .(6)

The ECTM selects an optimal CSₛ and the EVᵢ pays the price for the energy required to the optimal CSₛ. In an example, the price may be fixed. The SOC of the EVᵢ may be updated as follows:

The updated SOC, SOCᵢ^{upd}, for EVᵢ is equal to the present SOC, SOCᵢ^{prs}, plus the SOC given from CSₛ SOC_{s→i}^{giv} minus the SOC consumed by traveling from the location X to the CSₛ, SOC_{i→s}^{trv}, is given by:

SOCᵢ^{upd}=SOCᵢ^{prs}+SOC_{s→i}^{giv}−SOC_{i→s}^{trv} .(7)

The updated energy for EVᵢ is given by:

Eᵢ^{upd}=SOCᵢ^{upd}×Eᵢ^{rt} .(8)

The SOC wasted for EVᵢ while travelling to the CSₛ, SOC_{i→s}^{trv}, is given by:

$${SOC}_{i \to s}^{trv} = \frac{{d}_{i \to s}}{{D}_{i}^{max}} * {SOC}_{i}^{max} , \qquad ( 9 )$$

where Dᵢ^{max} is the maximum distance of i^{th} EV with respect to all available CSₛ.

The energy required for EVᵢ to travel to CSₛ, E_{i→s}^{trv}, may be calculated by:

E_{i→s}^{trv}=SOC_{i→s}^{trv}×Eᵢ^{rt} .(10)

As a result, the SOC for the CSₛ is updated as following:

The updated SOC, SOCₛ^{upd}for the CSₛ is equal to the present SOC, SOCₛ^{prs}, minus the SOC charged from the CSₛ, SOC_{s→i}^{giv}, that is:

SOCₛ^{upd}=SOCₛ^{prs}−SOC_{s→i}^{giv} .(11)

The updated energy for the CSₛ is given by:

Eₛ^{upd}=SOCₛ^{upd}×Eₛ^{rt} .(12)

The energy required by the EVᵢ should be less than or equal the rated battery capacity, that is:

0<Eᵢ^{req}≤Eᵢ^{rt}∀i. (13)

The energy available at the CSₛ should be less than or equal the rated battery capacity, that is:

0<Eₛ^{avl}≤Eₛ^{rt}∀S. (14)

In order to evaluate the total response time, the system 100 computes the following time components:

i. The time slot, τₙ, which EVᵢ arrives the CSₛ:

$${τ}_{n} = \frac{{T}_{i} + {T}_{i \to s}^{trv}}{τ} , \qquad ( 15 )$$

Where Tᵢ is the time at which the EVᵢ makes the request, T_{i→s}^{trv} is the travelling time, τ is the length of the time slot period and n is a finite number determined by system regarding the arrival of the EVᵢ at the CSₛ. For example, τᵢ represents a time slot between 9:30 am to 10 pm, and the time slot, τₙ is assigned to the arriving EVᵢ based upon the arrival time considering other factors such as traffic occurring in the travel path. In other words, time slot, τₙ, for n=1, 2, . . . , 48 (i.e., each half hour of a 24 hour day) represents a tentative time at which CSₛ is expecting the EVᵢ.

ii. The travelling time for EVᵢ to travel from its present location to the CS location:

$${T}_{i \to s}^{trv} = \frac{{d}_{i \to s}}{{s}_{i}} , \qquad ( 16 )$$

where sᵢ is the average speed for EVᵢ.

iii. The service charging time for EVᵢ at CSₛ:

T_{i,s}^{ch}={SOCᵢ^{req}−(SOCᵢ^{prs}−Rᵢ^{dis}×d_{i→s})}×Rₛ^{ch} ,(17)

where Rᵢ^{dis} is is the discharging rate for EVᵢ and Rₛ^{ch} is the charging rate at CSₛ.

iv. The waiting time of the CSₛ for EVᵢ:

T_{i,s}^{w}=Γ×ŷ_{s,n} ,(18)

where Γ is a constant chosen arbitrarily and ŷ_{s,n} is the traffic that is predicted at CSₛ at time slot n.

v. The total response time for EVᵢ to charge at the CSₛ:

T_{i,s}^{crs}=T_{i→s}^{trv}+T_{i,s}^{w}+T_{i,s}^{ch} .(19)

vi. The EV's satisfaction level after charging considering the updated energy and response time:

$${S}_{i}^{ch} = \frac{{E}_{i}^{upd}}{{E}_{i}^{rt}} \times α + ℵ \times β , \qquad ( 20 )$$

where α, β are percentages represent the importance of the factor level and

$$ℵ = 1 if \frac{{T}_{i , s}^{avl}}{{τ}_{i , s}^{CrS}} > 1 and \frac{{T}_{i , s}^{avl}}{{T}_{i , s}^{CrS}}$$

otherwise.

The outputs of the previous quantities are used in the assignment problem. To formulate the assignment problem, the system 100 considers following facts:

I. Decision variables:
X_{i,}− Equal to 1 if EVᵢ is assigned to the CSₛ and 0 otherwise.

II. Objective functions:
i. Maximizing the energy required for every EV:

Max CH=aᵢΣᵢ^{I}ln(bᵢ+Eᵢ^{req}×pₛ×X_{i,s}−E_{i→s}^{trv}×pₛ×X_{i,s}). (21)

ii. Minimizing the total response time:

Min CRT=Σᵢ^{I}Σₛ^{S}T_{i,s}^{crs}×X_{i,s} .(22)

where aᵢ and bᵢ are constants and pₛ is the price announced be the CS.

III. Constraints:
i. Every EV is assigned to only one CS:

ΣₛX_{i,s}≤1 ∀i (23)

ii. The overall energy given by CSₛ to all EVs assigned to the CSₛ should be less than or equal the available energy at that CS:

Σᵢ₌₁^{l}E_{s→i}^{giv}×X_{i,s}≤Eₛ^{avl}∀s (24)

iii. Energy given to EVᵢ is less than or equal to the energy required by the same EV:

Σₛ₌₁^{s}E_{s→i}^{giv}×X_{i,s}≤Eᵢ^{req}∀i. (25)

iv. Every EV should have enough revenue (Vᵢ) to pay for the energy price:

Σₛ₌₁^{s}pₛ×Eᵢ^{req}×X_{i,s}≤Vᵢ∀i. (26)

v. Energy updated for EVᵢ is:

Eᵢ^{upd}=Eᵢ^{prs}+E_{s→i}^{giv}−Σₛ₌₁^{s}E_{i→s}^{trv}×X_{i,s}∀i. (27)

vi. Energy updated for CSₛ is:

Eₛ^{upd}=Eₛ^{avl}−Σᵢ₌₁^{l}E_{s→i}^{giv}×X_{i,s}∀s. (28)

vii. Energy updated for EVi should be less than the battery capacity for the same EV:

Eᵢ^{upd}<Eᵢ^{rat} .(29)

viii. Energy given to the EVᵢ should be greater than the traveling energy:

Σₛ₌₁^{s}Eᵢ₌ₛ^{trv}×X_{i,s}<E_{s→i}^{giv} .(30)

ix. Total response time should be less than or equal to the maximum estimated response time:

Σᵢ^{l}Σₛ^{s}T_{i,s}^{crs}×X_{i,s}≤ϵ. (31)

where ϵ is a constant value.

x. Total number of EVs charging at CSₛ should be less than or equal to the CS capacity Cs:

ΣᵢX_{i,s}≤Cₛ∀s. (32)

xi. Binary Variable:

X_{i,s}={0,1}∀i,s. (33)

iii. None negativity:

T_{i,s}^{crs}, E_{s→i}^{giv}, Eᵢ^{upd}≥0. (34)

In EDTM, the EVᵢ requests to discharge energy to the CSₛ with the aim of discharging the maximum energy that it can sell for a favorable price, while retaining a battery state of charge that allows the EVᵢ to reach its destination. The SOC available, SOCᵢ^{avl}, is equal to the present SOC of the EVᵢ, SOCᵢ^{prs}, minus the SOC threshold, SOCᵢ^{avl}, that is:

SOCᵢ^{avl}=SOCᵢ^{prs}−SOCᵢ^{thr} .(35)

The energy available, Eᵢ^{avl}, at EVᵢ, is given by:

Eᵢ^{avl}=SOCᵢ^{avl}×Eᵢ^{rt} .(36)

To make sure that EVᵢ may participate in the discharging process, the present SOC at the EVᵢ, SOCᵢ^{prs}, should be greater than the threshold SOC, SOCᵢ^{thr}.

SOCᵢ^{prs}>SOCᵢ^{thr} .(37)

Every CS is supplied by two main sources: a renewable energy source (PV panels and/wind turbines) and discharging EVs. Therefore, the maximum energy at every CS may be calculated from:

Eₛ^{prs}=Eₛ^{ren}+Σᵢ₌₁^{I}Eᵢ^{dis} .(38)

The required SOC for CSₛ to receive the maximum level is:

SOCₛ^{req}=SOCₛ^{max}−SOCₛ^{prs} .(39)

The energy required for the CSₛ, Eₛ^{req}, is:

Eₛ^{req}=SOCₛ^{req}×Eₛ^{rt} ,(40)

where Eₛ^{rt} is the rated battery pool capacity of the CSₛ.

An EV that participates in the discharging process is assigned to the optimal CS and then discharges its energy. The CS pays the G2V price to the EV.

The updated SOC, SOCₛ^{upd} for each CSₛ is equal to the present SOC, SOCₛ^{prs} minus the SOC discharged from EVᵢSOC_{i→s}^{dis}, that is:

SOCₛ^{upd}=SOCₛ^{prs}−SOC_{i→s}^{dis} .(41)

The updated energy for each CSₛ is given by:

Eₛ^{upd}=SOCₛ^{upd}×Eₛ^{rt} .(42)

After discharging, the updated SOC, SOCᵢ^{upd} for EVᵢ is equal to the present SOC, SOCᵢ^{prs} minus the SOC given to the CS SOC_{i→s}^{giv} minus the SOC consumed during travel from the EV location to the CS SOC_{i→s}^{trv}.

SOCᵢ^{upd}=SOCᵢ^{prs}−SOC_{i→s}^{giv}−SOC_{i→s}^{trv} .(43)

The updated energy for EVᵢ:

Eᵢ^{upd}=SOCᵢ^{upd}×Eᵢ^{rt} .(44)

The energy required by CSₛ should be less than or equal to the rated battery capacity:

0<Eₛ^{req}≤Eₛ^{rt}∀ₛ .(45)

The present energy available at CSₛ should be less than or equal to the rated battery capacity:

0<Eₛ^{prs}÷Eₛ^{rt}∀ₛ .(46)

Every CSₛ should have enough revenue (Vₛ) to pay for the energy price:

Σₛ₌₁^{s}Σᵢ₌₁pᵢ×Eₛ^{req}≤Vₛ .(47)

The energy price announced by EVᵢ is given by:

$${P}_{i} = δ \times ( \frac{{soc}_{i}^{max}}{{soc}_{i}^{avl} - {SOC}_{i}^{thr}} ) \qquad ( 48 )$$

where δ is a constant to guarantee that the overall price is greater than the buying price.

Thus, to find the total response time, the system 100 computes the following components in a manner similar to computing the ECTM:
i. The time slot in which EVᵢ arrives the CSₛ are calculated from equation (15).
ii. The travelling time for EVᵢ to travel from its present location to the CS location is given by equation (16).

The service discharging time for each EVᵢ at CSₛ is given by:

T_{i,s}^{dis}={(SOCᵢ^{prs}−Rᵢ^{dis}×d_{i→s})−SOCᵢ^{thr}}33 Rₛ^{dis} .(49)

Equation (18) represents the waiting time for EVᵢ at the CSₛ.

The total response time for EVᵢ to discharge at the CSₛ:

T_{i,s}^{drs}=T_{i→S}^{trv}+T_{i,s}^{w}+T_{i,s}^{dis} .(50)

EVs satisfaction level after discharging considering the sold energy and response time:

$${S}_{i}^{dis} = \frac{{E}_{i \to s}^{giv}}{{E}_{i}^{avl}} \times α + ℵ \times β . \qquad ( 51 )$$

where α, β re percentages represent the importance of the factor level and

$$ℵ = 1 if \frac{{T}_{i , s}^{avl}}{{T}_{i , s}^{drs}} > 1$$

and 0, otherwise.

The output of the previous equations is used in the assignment problem. To formulate the assignment problem, the present model considers the following:

A. Decision variables:
X_{i,}=Equal to 1 if EVᵢ is assigned to the CSₛ and 0 otherwise.

B. Objective function:
i. Maximizing the energy required for every CS:

Max DSH=αₛΣₛ^{s}ln(bₛ+Eₛ^{req}×pₛ×X_{i,s}). (52)
ii. Minimizing the total response time:

Min DRT=Σᵢ^{I}Σₛ^{s}T_{i,s}^{drs}×X_{i,s} .(53)

where αₛ and bₛ are constants and pₛ is the price announced by the CS.

C. Constraints:
i. Every EV is assigned to only one CS:

ΣₛX_{i,s}≤1∀i. (54)
ii. Every CSₛ should have enough revenue (Vₛ) to pay for the energy price:

Σᵢ₌₁^{I}pᵢ×Eᵢ^{req}×X_{i,s}≤Vₛ∀s. (55)

iii. Energy updated for EVᵢ:

Eᵢ^{upd}=Eᵢ^{prs}−E_{i→s}^{dis}×X_{i,s}−Σₛ^{s}E_{i→s}^{trv}×X_{i,s}∀i. (56)
iv. Energy updated for CSₛ:

Eₛ^{upd}=Eₛ^{prs}+Eₛ^{ren}+Σᵢ^{I}E_{i→s}^{dis}×X_{i,s}∀s. (57)
v. Updated energy at CSₛ should be less than or equal to the rated pool capacity:

Eₛ^{prs}+Eₛ^{ren}+Σᵢ^{I}E_{i→s}^{dis}×X_{i,s}≤Eₛ^{rat}∀s. (58)
vi. Total response time should be less than or equal to the maximum estimated response time:

Σᵢ^{I}Σₛ^{s}T_{i,s}^{drs}×X_{i,s}≤ϵ. (59)

where ϵ is a constant value.
vii. Total number of EVs discharging at CSₛ should be less than or equal to the CS capacity Cs:

ΣᵢX_{i,s}≤Cₛ∀s. (60)
viii. Binary Variable:

X_{i,s}=0,1 ∀i,s. (61)
ix. None negativity:

T_{i,s}^{drs}, Eₛ^{upd}, Eᵢ^{upd}, E_{i→s}^{dis} .(62)

In the EM, the EV cannot travel to any available CS with its present SOC, therefore the EV must call for emergency service. The EM may have a number of mobile CS (MCS) 116 placed at fixed locations along the route of the EVᵢ. This model is based on the asymmetric travelling salesperson problem in which the goal is to find the shortest tour starting from the location of the MCS 116 and ending in the same place. For the system of the present disclosure, the distance from the MCS 116 location to the EV locations is different than in the travelling salesperson model. The present system 100 assumes the locations of the MCS 116 are placed randomly and the request for emergency charging is coming from the fog and cloud-based charging service application 112 where the present energy is less than the travelling energy to all available charging stations.

In an aspect of the present disclosure, there are a number of mobile CSS 116. However, in testing the present system, it was assumed that there was only one CS 116.

Decision variables:

Y_{a,}=1, if the EVᵢ at location a is reached by the mobile CS from a location b and 0 otherwise.

Objective function:

Minimizing the total tour distance given by:

Max z=Σₐ¹Σ_{b}¹d_{a,b}×Y_{a,b} (63)

where d_{a,b} is the distance from the location j to location i.

Constraints:
i. Only one entry location for a location:

$${\sum }_{{a = 1}_{a \neq b}} {Y}_{a , b} \leq 1 ∀ b . \qquad ( 64 )$$

ii. Only one exit location for a location:

$${\sum }_{{b = 1}_{b \neq a}} {Y}_{a , b} \leq 1 ∀ a . \qquad ( 65 )$$

iii. Braking subtours (a subtour is a tour that is not connecting all locations):
Let nₐ be a non-negative variable which represents the number of locations visited before reaching location b, b>1 (assuming the tour starts from location 1), so the relationship between Xj,i, nₐ and n_{b} can be represented as:
If Y_{j,}=1 then nₐ+1≤n_{b}, while Xj,=0, there is no relationship between them. Therefore, the constraint is given by:

nₐ+1≤n_{b}+M(1−Xj,i)∀a, b & a≠b, (66)

where M is a big number that is bigger than nₐ and the best estimate for M is the total number of locations −1.
iv. Binary Variable:

Y_{a,b}=0,1 ∀a, b (67)
v. Non negative constraint:

nₐ≥0∀a (68)

The system 100 was tested on 40 EVs distributed among 6 different types of EVs (Toyota Prius, Chevy Spark, Mitsubishi iMiEV, BMW i3, Nissan LEAF and Tesla S), 4 CS, and one MCS. The experiment considered an urban city divided into d*d blocks like a Manhattan block city architecture. For example, d is considered as 5, then the urban city is divided into (5*5 km²) blocks, similar with the Manhattan layout. In an aspect, in the experiment, real CSₛ data taken from the Hawaiian Electric Company website was used. The charging station data is summarized in Table 1.

TABLE 1
Specifications of charging stations

| | Charger | Public | | Price |
|---|---|---|---|---|
| CS | type | access | Time of use period | ($/Kwh) |
| Oahu (1) | DC Fast | 24 hrs | Mid-Day (9 a.m.-5 p.m.) | 0.49 |
| | Charger | | | |
| Maui (2) | DC Fast | 24 hrs | Mid-Day (9 a.m.-5 p.m.) | 0.49 |
| | Charger | | | |
| Molokai (3) | DC Fast | 24 hrs | Mid-Day (9 a.m.-5 p.m.) | 0.54 |
| | Charger | | | |
| Hawaii | DC Fast | 24 hrs | Mid-Day (9 a.m.-5 p.m.) | 0.51 |
| Island (4) | Charger | | | |

The coordinates of each CSₛ location (x, y) was generated randomly using uniform distribution, for x between [0-25] and y a discrete value from the set [0, 5, 10, 15, 20, 25]. In addition, the coordinates of the EVs location (x, y) were generated in the same way. The other parameters of the CSₛ is shown in Table 2.

TABLE 2
Charging Station Parameters.

| Parameter | Value |
|---|---|
| a | 1.5 |
| b | 1 |
| SOCₛ^{thr} (charging) | 0% |
| SOCₛ^{thr} (discharging) | 40% |
| Eₛ^{rt} | 100 kWh |

In an aspect, during experimentation, only one-time slot, which is the mid-day time, was considered. Requests were collected within 15 seconds and charging stations were allocated. During experiments, a random number from 0 to 15 for the request time was generated. Then, the travelling time and charging/discharging times were calculated using the time response model. Further, during experiments, the average speed was assumed to be constant for all EVs i.e., 30 km/h. The travelling time did not play a critical role in the allocation because the primary factor for the assignment is the distance. Also, the waiting time and the charging/discharging times are important for the total response time. These times are different from one CS to another CS because it depends on the charging/discharging rates for every CS. These rates are generated randomly using Table 4. For the waiting times to plug in, the system used the results (0.28, 0.4, 0.32 and 0.34) for CSₛ (1, 2, 3, 4), respectively, with equal probabilities for all EVs.

The present SOC for every EV and CS was generated randomly using a uniform distribution between (0, 100). In addition, the rated energy capacity is generated randomly using Table 3.

TABLE 3
EVs battery Specifications

| | Battery | Electric | Charging | Charging |
|---|---|---|---|---|
| | capacity | range | voltage | current |
| Model | Eᵢ^{rt} kWh) | (km) | (VAC) | (A) |
| Toyota Prius | 4.4 | 18 | 230 | 15 |
| Chevy Spark | 21.3 | 132 | 230 | 15 |
| Mitsubishi iMiEV | 16 | 128 | 230 | 15 |
| BMW i3 | 22 | 160 | 230 | 30 |
| Nissan LEAF | 24 | 160 | 230 | 30 |
| Tesla S | 70 | 390 | 265 | 40 |

TABLE 4
Time Response Model Parameters

| | | |
|---|---|---|
| Discharge rate | 0.1-2.5 | kWh/mile |
| Charging rate | 1-5 | kWh |
| EV avg. speed | 30-40 | mph |

| | |
|---|---|
| ε | 30 |

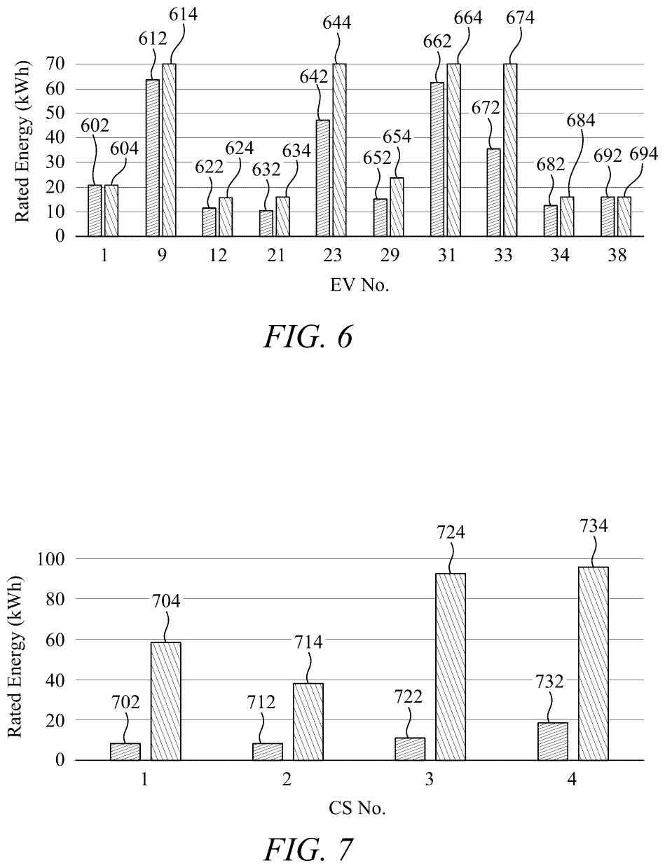

Based on the SOCᵢ^{thr}, the system 100 divided the EVs into (charging & discharging) requests. If the SOC i Prs was less than or equal the SOCᵢ^{thr}, the request was considered as a charging request, otherwise it was designated as a discharging request. For charging requests, the EVs were assigned to the optimal CS if the SOCᵢ^{prs} was greater than or equal to the minimum SOC_{i→s}^{trv}, otherwise the EV would use the EM. During the experiment, there were 20 requests for charging and 10 of them could travel to the nearest CS with its present SOC. These 10 EVs used the charging model to select the optimal CS based on the distance as a major factor and the price with the total response time as a secondary factor. The assignment result of the charging model is shown in FIG. 5. As shown in FIG. 5, the value for the objective function (as calculated using equations 21 and 22) is (26.850). For example, the objective function may consider a maximized energy required for every EV, and a minimized the total response time. Further, FIG. 6 represents updated energy of EVs Eᵢ^{upd} after using the charging service, and FIG. 7 represents updated energy of CSₛEₛ^{upd} after using the fog and cloud-based charging service application

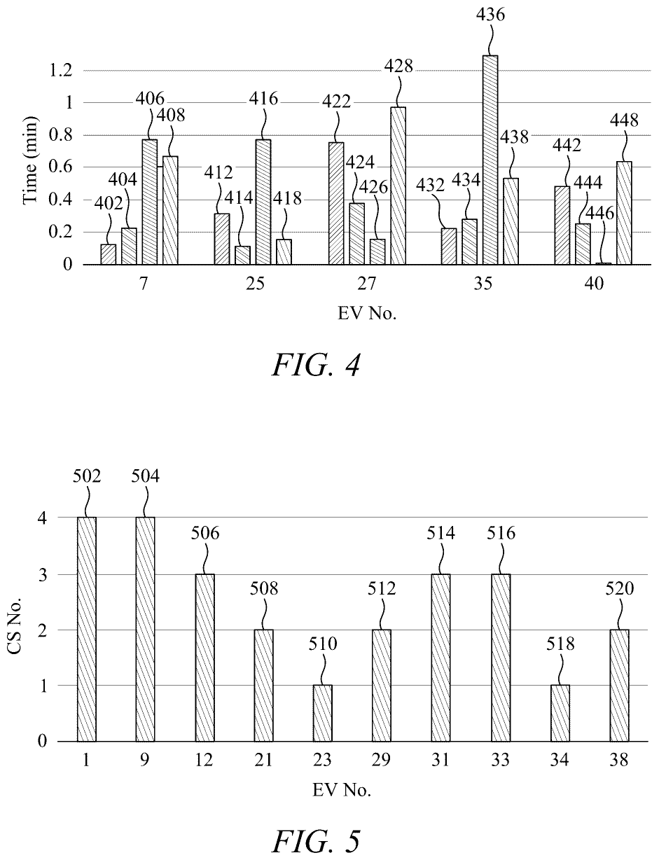

FIG. 4 is a graph representing a discharging time for various EVs with respect to various CSₛ. For example, bar 402 illustrates a discharging time for an EV₇ corresponding to CS₁. Bar 404 illustrates the discharging time for the EV₇ corresponding to CS₂. Bar 406 illustrates the discharging time for the EV₇ corresponding to CS₃. Bar 408 illustrates the discharging time corresponding to CS₄. Similarly, for EV₂₅, bar 412 illustrates a discharging time for the EV₂₅ corresponding to CS₁. Bar 414 illustrates the discharging time corresponding to C₅₂. Bar 416 illustrates the discharging time for the EV₂₅ corresponding to CS₃. Bar 418 illustrates the discharging time for the EV₂₅ corresponding to CS₄. Also, for EV₂₇, bar 422 illustrates a discharging time for the EV₂₇ corresponding to CS₁. Bar 424 illustrates the discharging time corresponding to C₅₂. Bar 426 illustrates the discharging time corresponding to CS₃. Bar 428 illustrates the discharging time for the EV₂₇ corresponding to CS₄. Also, for EV₃₅, bar 432 illustrates a discharging time for the EV₃₅ corresponding to CS₁. Bar 434 illustrates the discharging time corresponding to CS₂. Bar 436 illustrates the discharging time corresponding to CS₃. Bar 438 illustrates the discharging time for the EV₃₅ corresponding to CS₄. For EV₄₀, bar 442 illustrates a discharging time for the EV₄₀ corresponding to CS₁. Bar 444 illustrates the discharging time corresponding to CS₂. Bar 446 illustrates the discharging time corresponding to CS₃. Bar 448 illustrates the discharging time for the EV₄₀ corresponding to CS₄.

FIG. 5 is a graph representing assigning EVs to the optimal CS using the fog and cloud-based charging service application. Bar 502 illustrates assignment of EV₁ to the optimal CS₄. Bar 504 illustrates assignment of EV₉ to the optimal CS₄. Bar 506 illustrates assignment of EV₁₂ to the optimal CS₃. Bar 508 illustrates assignment of EV₂₁ to the optimal CS₂. Bar 510 illustrates assignment of EV₂₃ to the optimal CS₁. Bar 512 illustrates assignment of EV₂₉ to the optimal CS₂. Bar 514 illustrates assignment of EV₃₁ to the optimal CS₃. Bar 516 illustrates assignment of EV₃₃ to the optimal CS₃. Bar 518 illustrates assignment of EV₃₄ to the optimal CS₁. Bar 520 illustrates assignment of EV₃₈ to the optimal CS₂.

FIG. 6 is a graph representing the updated energy of various EVs after using the charging service. Bar 602 illustrates an updated energy of EV₁ and bar 604 illustrates the maximum capacity of EV₁. Bar 612 illustrates an updated energy of EV₇ and bar 614 illustrates the maximum capacity of EV₇. Bar 622 illustrates an updated energy of EV₁₂ and bar 624 illustrates the maximum capacity of EV₁₂. Bar 632 illustrates an updated energy of EV₂₁ and bar 634 illustrates the maximum capacity of EV₂₁. Bar 642 illustrates an updated energy of EV₂₃ and bar 644 illustrates the maximum capacity of EV₂₃. Bar 652 illustrates an updated energy of EV₂₉ and bar 654 illustrates the maximum capacity of EV₂₉. Bar 662 illustrates an updated energy of EV₃₁ and bar 664 illustrates the maximum capacity of EV₃₁. Bar 672 illustrates an updated energy of EV₃₃ and bar 674 illustrates the maximum capacity of EV₃₃. Bar 682 illustrates an updated energy of EV₃₄ and bar 684 illustrates the maximum capacity of EV₃₄. Bar 692 illustrates an updated energy of EV₃₈ and bar 694 illustrates the maximum capacity of EV₃₈.

FIG. 7 is a graph representing the updated rated energy of the CS for the fog and cloud-based charging service application. Bar 702 illustrates an updated energy of CS₁ after charging an EV, and bar 704 illustrates an available energy of CS₁ after charging the EV. Bar 712 illustrates an updated energy of CS₂ after charging an EV, and bar 714 illustrates an available energy of CS₂ after charging the EV. Bar 722 illustrates an updated energy of CS₃ after charging an EV, and bar 724 illustrates an available energy of CS₃ after charging the EV. Bar 732 illustrates an updated energy of CS₄ after charging an EV, and bar 734 illustrates an available energy of CS₄ after charging the EV.

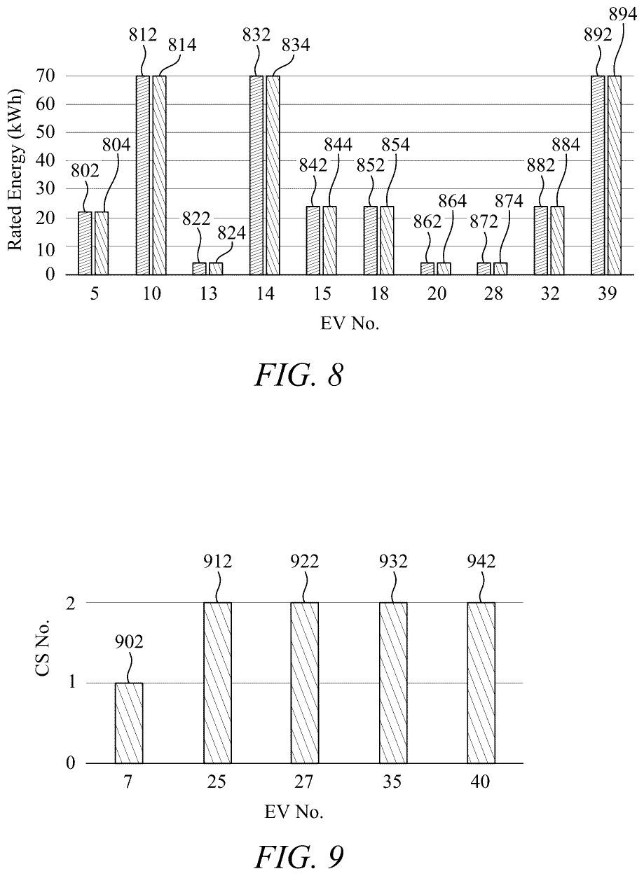

In the experiment, the other 10 EVs were tested using the MCS 116. It was assumed that each MCS 116 would provide sufficient batteries (to the maximum level) to charge four EV batteries completely. In an example, the energy capacity for the MCS is 70*4=280 kWh. For example, the MCSs 116 was placed randomly in the smart city of FIG. 3, and the distance matrix between each pair of EVs was generated. The updated energy for the EVs is shown in FIG. 8. FIG. 8 illustrates a graph representing updated EV energy after charging from a mobile charging station (MCS). Bar 802 illustrates an updated energy of EV₅ and bar 804 illustrates the maximum capacity of EV₅. Bar 812 illustrates an updated energy of EV₁₀ and bar 814 illustrates the maximum capacity of EV₁₀. Bar 822 illustrates an updated energy of EV₁₃ and bar 824 illustrates the maximum capacity of EV₁₃. Bar 832 illustrates an updated energy of EV₁₄ and bar 834 illustrates the maximum capacity of EV₁₄. Bar 842 illustrates an updated energy of EV₁₅ and bar 844 illustrates the maximum capacity of EV₁₅. Bar 852 illustrates an updated energy of EV₁₈ and bar 854 illustrates the maximum capacity of EV₁₈. Bar 862 illustrates an updated energy of EV₂₀ and bar 864 illustrates the maximum capacity of EV₂₀. Bar 872 illustrates an updated energy of EV₂₈ and bar 874 illustrates the maximum capacity of EV₂₈. Bar 882 illustrates an updated energy of EV₃₂ and bar 884 illustrates the maximum capacity of EV₃₂. Bar 892 illustrates an updated energy of EV₃₉ and bar 894 illustrates the maximum capacity of EV₃₉.

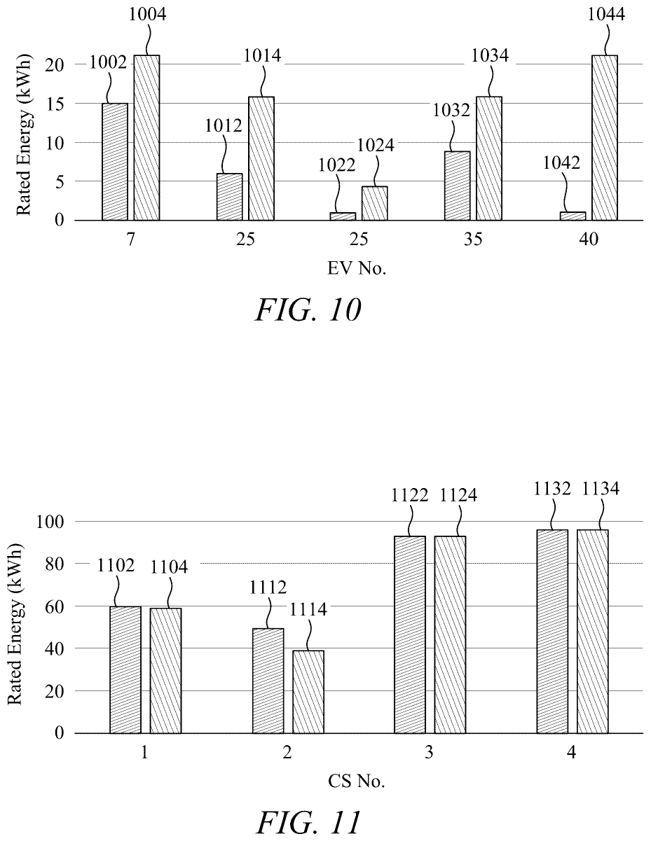

For the discharging requests, the discharging model assigns those EVs to the optimal CS. In an example, there were 20 discharging requests during experiments. First, the system 100 checked if the EV had a sufficient energy to trade with the CS by comparing Eᵢ^{avl} with the minimum E_{i→s}^{trv}. If the Eᵢ^{avl} is greater than the minimum E_{i→s}^{trv}, then the EV was be assigned to the optimal CS based on the distance as the primary factor and the price with the total response time as secondary factor. If the Eᵢ^{avl} is less than the minimum E_{i→s}^{trv}, then the system 100 provides a suggestion to the EV for charging the battery, and the discharging request may be rejected. After that, 15 requests were rejected and only 5 were accepted. The allocation results are presented in FIG. 9 and the updated energy for the EVs and the CS is shown in FIG. 10 and FIG. 11, respectively.

FIG. 9 is a graph representing assigning EVs to the optimal CS using the discharging model. Bar 902 illustrates assignment of EV₇ to the optimal CS₁. Bar 912 illustrates assignment of EV₂₅ to the optimal C₅₂. Bar 922 illustrates assignment of EV₂₇ to the optimal C₅₂. Bar 932 illustrates assignment of EV₃₅ to the optimal C₅₂. Bar 942 illustrates assignment of EV₄₀ to the optimal CS₂.

FIG. 10 is a graph representing the updated EVs energy after using the discharging model. Bar 1002 illustrates an updated energy of EV₇ and bar 1004 illustrates the maximum capacity of EV₇. Bar 1012 illustrates an updated energy of EV₂₅ and bar 1014 illustrates the maximum capacity of EV₂₅. Bar 1022 illustrates an updated energy of EV₂₇ and bar 1024 illustrates the maximum capacity of EV₂₇. Bar 1032 illustrates an updated energy of EV₃₅ and bar 1034 illustrates the maximum capacity of EV₃₅. Bar 1042 illustrates an updated energy of EV₄₀ and bar 1044 illustrates the maximum capacity of EV₄₀.

FIG. 11 is a graph representing the updated CS energy after the discharging model. Bar 1102 illustrates an updated energy of CS₁ after discharging, and bar 1104 illustrates an available energy of CS₁ after discharging. Bar 1112 illustrates an updated energy of CS₂ after discharging, and bar 1114 illustrates an available energy of CS₂ after discharging. Bar 1122 illustrates an updated energy of CS₃ after discharging, and bar 1124 illustrates an available energy of CS₃ after discharging. Bar 1132 illustrates an updated energy of CS₄ after discharging and bar 1134 illustrates an available energy of CS₄ after discharging.

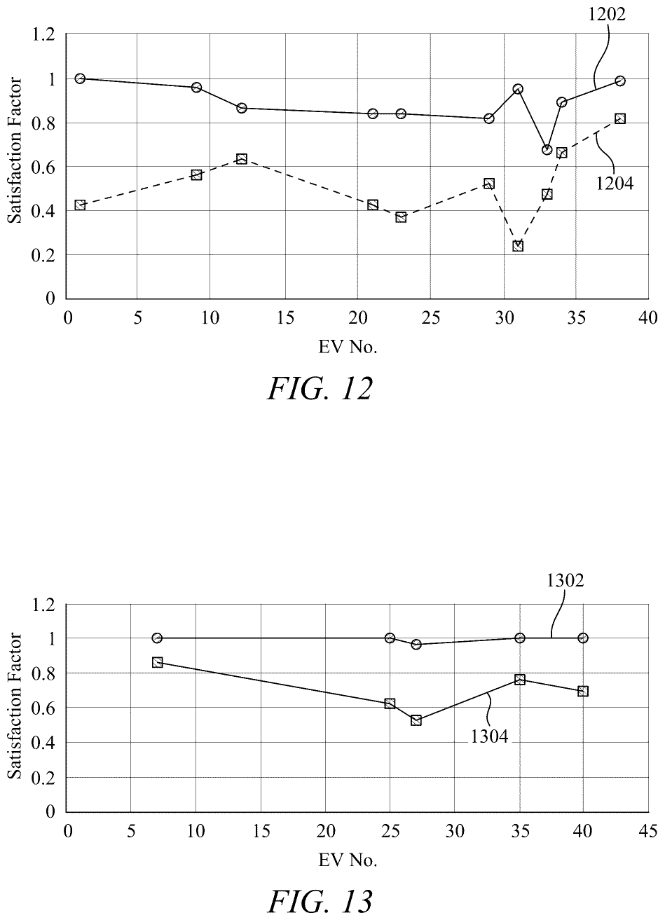

To validate the present system 100, two scenarios were compared. In first scenario, it was assumed that there was no response time consideration, and the EM was not implemented. In second scenario, the EDTM and the ECTM were implemented. The satisfaction level was higher than first scenario for both charging/discharging models as shown in FIG. 12 and FIG. 13, respectively. FIG. 12 is a graph representing the satisfaction factor for charging EVs. Plot line 1202 illustrates the satisfaction factor for charging EVs for the first scenario, and plot line 1204 illustrates the satisfaction factor for charging EVs for the second scenario (with the system of the present disclosure).

FIG. 13 is a graph representing the satisfaction factor for discharging EVs. Plot line 1302 illustrates the satisfaction factor for discharging EVs for the first scenario, and plot line 1304 illustrates the satisfaction factor for discharging EVs for the second scenario (with the system of the present disclosure).

As shown in Table 5, the number of served requests was higher in the second scenario. In the second scenario, the emergency model was serving the EVs that could not travel with 100% of the served energy level while the first scenario rejected those EVs. In summary, the results proved that the combined (charging/discharging) models increased the satisfaction level for EVs and EVs can travel on a single battery charge due to availability of the charging stations.

TABLE 5
Number of EVs served in the two scenarios.

| | No. of served EVs | Satisfaction level of not traveling EVs |
|---|---|---|
| scenario 1 | 15 | 0 |
| scenario 2 | 25 | 1 |

The system 100 implements two (charging/discharging) models to allocate EVs to the optimal CSₛ such that maximizing trading energy and minimizing response time. Moreover, an emergency model is included to serve the EVs that cannot be served by the (ECTM) which maximizes energy trading and maximizes the number of EVs served. To verify that the models perform efficiently, comprehensive simulation results were presented.

The system 100 is configured to implement the ECTM that is a combination of an energy charging model based on the state of charge (SOC) and a total response time model considering travelling time, charging service time, and waiting time at the CS to plug-in.

In another aspect, the present system is configured to implement the EDTM that is a combination of an energy discharging model based on the state of charge (SOC) and the total response time model considering travelling time, discharging service time, and waiting time at the CS to plug-in.

In an example, the output of ECTM and EDTM is used as parameters input for the assignment problem. The objective of the assignment problem is to find the optimal CS with maximizing energy needed and minimizing total response time. To combine the multi-objectives in one formulation model, the energy objective is considered and the time objective is restricted to driver expectations using the ϵ-Constraint Method. In an example, the ϵ-constraint method is configured to solve bi-objective combinatorial optimization problems. In the ϵ-constraint method, one of the objective functions is optimized while using the other objective functions as constraints.

The first embodiment is illustrated with respect to FIGS. 1-3. The first embodiment describes a method for assigning an electric vehicle to a charging station by a fog and cloud-based charging service application 112. The method includes receiving, by a computing device 106 of the fog and cloud-based charging service application 112, a request from an electric vehicle EVᵢ for a charging station assignment at a time Tᵢ, where i=1, 2, . . . , I; receiving, by the computing device 106, a position of the electric vehicle EVᵢ and a route of the electric vehicle EVᵢ; receiving, by the computing device 106, a present state of charge SOCᵢ^{prs}, a threshold state of charge SOCᵢ^{thr} and a maximum state of charge SOCᵢ^{max} of a battery of the electric vehicle EVᵢ; identifying, by the computing device 106, a number S of charging stations CSₛ, for s=1, 2, . . . , S, along the route of the electric vehicle EVᵢ; calculating, by the computing device 106, a travelling distance d_{i→s} of the electric vehicle EVᵢ to each charging station CSₛ; calculating, by the computing device 106, a travelling time T_{i→s}^{trv} for the electric vehicle EVᵢ to travel from the position to each charging station CSₛ; determining, by the computing device 106, a decrease SOC_{i→S}^{trv} in the present state of charge SOCᵢ^{prs} of the battery of the electric vehicle EVᵢ, based on the travelling distance d_{i→S} to each charging station CSₛ; calculating, by the computing device 106, an updated state of charge SOCᵢ^{upd} of the battery of the electric vehicle by subtracting the decrease in the present state of charge SOC_{i→s}^{trv} from the present state of charge SOCᵢ^{prs}; calculating, by the computing device 106, an amount of energy required Eᵢ^{req} to charge the battery of the electric vehicle EVᵢ at each charging station CSₛ based on a difference between a maximum state of charge SOCᵢ^{max} of the EVᵢ and the updated state of charge SOCᵢ^{upd} and multiplying the difference by an energy rating Eᵢ^{rt} of a battery of the electric vehicle EVᵢ; when the updated state of charge SOCᵢ^{upd} is greater than the threshold state of charge SOCᵢ^{thr}, calculating an amount of available energy Eᵢ^{avl} to discharge from the battery to the charging station CSₛ by multiplying a difference between the updated state of charge SOCᵢ^{upd} and the threshold state of charge SOCᵢ^{upd} by the energy rating Eᵢ^{rt}; receiving, by the computing device 106, a vehicle-to-grid, V2G, energy credit and a grid-to-vehicle, G2V, energy cost from each charging station CSₛ; receiving, by the computing device 106, from each charging station CSₛ a service charging time T_{i,s}^{ch} to charge the battery of the electric vehicle EVᵢ; receiving, by the computing device 106, from each charging station CSₛ a service discharging time T_{i,s}^{dis} to charge the battery of the electric vehicle EVᵢ; receiving, by the computing device 106, from each charging station a wait time T_{i,s}^{w} to access a charger; calculating, by the computing device 106, a total charging response time T_{i,s}^{crs} for the battery of the electric vehicle EVᵢ to charge at each charging station, based on the travelling time T_{i→s}^{trv}, the service charging time T_{i,s}^{ch} and the wait time T_{i,s}^{w}; calculating, by the computing device 106, a total discharging response time T_{i,s}^{drs} for the battery of the electric vehicle EVᵢ to discharge at each charging station, based on the travelling time T_{i→s}^{trv}, the service discharging time T_{i,s}^{dis} and the wait time T_{i,s}^{w}; receiving, by the computing device 106, an energy available Eₛ^{avl} at each charging station CSₛ; determining, by the computing device 106, an optimal charging station CSₒₚₜ based at least on one of the amount of energy required Eᵢ^{req} to charge the battery of the electric vehicle EVᵢ at each charging station CSₛ and the amount of energy available Eᵢ^{avl} to discharge the battery of the electric vehicle EVᵢ; further based on the V2G energy credit of each charging station CSₛ, the G2V energy cost of each charging station CSₛ, the amount of energy available Eₛ^{avl} at each charging station CSₛ, a minimum total charging response time T_{i,s}^{crs} at each charging station CSₛ, a minimum total discharging response time T_{i,s}^{drs} at each charging station CSₛ, a maximum amount of energy to be delivered to the battery of the electric vehicle EVᵢ and a maximum amount of energy to be delivered to each CSₛ; transmitting, by the computing device 106, a route to the optimal charging station CSₒₚₜ to the electric vehicle EVᵢ; receiving, by the computing device 106, a notice from the electric vehicle EVᵢ that it has arrived at the optimal charging station CSₒₚₜ; then, transmitting, by the computing device 106, one of a charging command to the optimal charging station CSₒₚₜ to charge the battery of the electric vehicle EVᵢ to the maximum state of charge SOCᵢ^{max} and a discharging command to the optimal charging station CSₒₚₜ to discharge the battery of the EVᵢ to the threshold state of charge SOCᵢ^{thr}; and calculating, by the computing device 106, an updated energy Eᵢ^{upd} stored in the battery of the electric vehicle EVᵢ.

The method further includes receiving, by the computing device 106, a rated energy capacity of each charging station CSₛ and a total number of electric vehicles charging at each charging station CSₛ; and estimating, by the computing device 106, whether the rated energy capacity of each charging station CSₛ is sufficient to provide the required energy to charge the battery of the electric vehicle to the maximum state of charge SOCᵢ^{max}.

When the updated state of charge SOCᵢ^{upd} is greater than the threshold state of charge SOCᵢ^{thr}, the method further includes calculating, by the computing device 106, a credit for the electric vehicle to discharge its energy to the threshold state of charge SOCᵢ^{thr} at the each charging station CSₛ and determining which charging station CSₛ offers the highest energy credit; when the updated state of charge SOCᵢ^{upd} is less than or equal to the threshold state of charge SOCᵢ^{thr}, calculating, by the computing device 106, an energy cost to charge the battery of the electric vehicle EVᵢ to its maximum state of charge SOCᵢ^{max} at each charging station CSₛ, and determining which charging station has the lowest energy cost; and determining, by the computing device 106, the optimal charging station CSₒₚₜ based at least on one of the highest energy credit and the lowest energy cost. The method includes assigning the optimal charging station CSₒₚₜ to the electric vehicle EVᵢ.

The method further includes calculating, by the computing device 106, a satisfaction level of the EVᵢ after one of charging and discharging based on the updated state of charge SOCᵢ^{upd} and the total response time T_{i,s}^{crs} at the optimal charging station CSₒₚₜ.

The method further includes receiving, by the computing device 106, a first satisfaction level weight α and a second satisfaction level weight β; generating, by the computing device 106, a charging energy factor by dividing the updated state of charge SOCᵢ^{upd} by the energy rating Eᵢ^{rt}; generating, by the computing device 106, a charging time factor by dividing a time slot available T_{i,s}^{avl} at the optimal CSₒₚₜ, by the total response time T_{i,s}^{crs}; multiplying, by the computing device 106, the charging energy factor by the first satisfaction level weight α and generating a weighted charging energy factor; multiplying, by the computing device 106, the charging time factor by the second satisfaction level weight α and generating a weighted charging time factor; and calculating a charging satisfaction level Sᵢ^{ch} of the EVᵢ by adding the weighted charging energy factor to the weighted charging time factor.

The method further includes estimating, by the computing device 106, an estimated charging satisfaction level S_{i,est}^{ch} of the EVᵢ at each CSₛ; and calculating the optimal charging station CSₛ based in part on the estimated charging satisfaction level S_{i,est}^{ch} of the EVᵢ.

The method further includes receiving, by the computing device 106, a first satisfaction level weight α and a second satisfaction level weight β; generating, by the computing device 106, a discharging energy factor by dividing the energy discharged E_{i→s}^{giv} by the electric vehicle EVᵢ to the optimal charging station CSₛ by the amount of available energy Eᵢ^{avl} in the battery of the electric vehicle EVᵢ; generating, by the computing device 106, a discharging time factor by dividing a time slot available T_{i,s}^{avl} at the optimal charging station CSₒₚₜ, by the total discharging response time T_{i,s}^{drs}; multiplying, by the computing device 106, the discharging energy factor by the first satisfaction level weight α and generating a weighted discharging energy factor; multiplying, by the computing device 106, the discharging time factor by the second satisfaction level weight α and generating a weighted discharging time factor; and calculating a discharging satisfaction level Sᵢ^{dis} of the EVᵢ by adding the weighted discharging energy factor to the weighted discharging time factor.

The method further includes estimating, by the computing device 106, an estimated discharging satisfaction level S_{i,est}^{dis} of the EVᵢ at each CSₛ; and calculating the optimal charging station CSₛ based in part on the estimated discharging satisfaction level S_{i,est}^{dis} of the EVᵢ.

When the decrease SOC_{i→s}^{trv} in the present state of charge SOCᵢ^{prs} of the battery of the electric vehicle EVᵢ, is greater than or equal to the threshold state of charge SOCᵢ^{thr}, the method further includes determining, by the computing device 106, that an optimal charging station CSₒₚₜ cannot be determined; searching, by the computing device 106, for mobile charging stations within a specified travelling distance of the electric vehicle EVᵢ; determining, by the computing device 106, a location of each of a plurality of mobile charging stations within the specified travelling distance; determining, by the computing device 106, a travel distance from each mobile charging station to the electric vehicle EVᵢ; identifying, by the computing device 106, the mobile charging station which has a shortest travel distance to the electric vehicle EVᵢ; and requesting, by the computing device 106, that the mobile charging station which has the shortest travel distance travel to the electric vehicle EVᵢ and deliver an amount of energy needed to increase the present state of charge SOCᵢ^{prs} of the battery of the electric vehicle EVᵢ to the maximum state of charge SOCᵢ^{max}.

In an aspect, the energy available at each charging station EVₛ is stored in a charging station battery, which is recharged by energy generated by a plurality of photovoltaic panels and by energy received from discharging electric vehicles.

When an amount of energy available Eₛ^{avl} at each charging station CSₛ is less than the amount of energy needed to increase the present state of charge SOCᵢ^{prs} of the battery of the electric vehicle EVᵢ to the maximum state of charge SOCᵢ^{max}, the method further includes identifying, by the computing device 106, a charging station which has the minimum total response time T_{i,s}^{crs} of the number S of charging stations CSₛ; selecting the charging station which has the minimum total response time T_{i,s}^{crs} as the optimal charging station CSₒₚₜ; and transmitting, by the computing device 106, a command to the optimal charging station CSₒₚₜ which has the minimum total response time T_{i,s}^{crs} to charge the battery of the electric vehicle EVᵢ with energy sourced from a utility grid.

The method further includes registering each electric vehicle EVᵢ for all i=1, 2, . . . , I with the fog and cloud-based charging service application 112 by the computing device 106, and registering each charging station CSₛ for all s=1, 2, . . . , S with the fog and cloud-based charging service application 112 by the computing device 106.

In an aspect, the fog and cloud-based charging service application 112 further includes a SDN controller application 104 configured to manage network communications of the fog and cloud-based charging service application.

The method further includes applying, by the computing device 106, the following constraints in determining the optimal charging station CSₒₚₜ when charging the battery of the electric vehicle EVᵢ; the electric vehicle EVᵢ is assigned to only one CSₛ, a total energy transferred to the batteries of all electric vehicles assigned to a charging station CSₛ is less than or equal to the available energy Eₛ^{avl} of the CSₛ, the electric vehicle EVᵢ must be able to pay a price for charging its battery, the updated energy Eᵢ^{upd} stored in the battery of the electric vehicle EVᵢ after charging equals the present state of charge SOCᵢ^{prs} multiplied by the energy rating Eᵢ^{rt} of the battery of the electric vehicle EVᵢ, plus the energy delivered by the optimal CSₒₚₜ to the battery of the electric vehicle EVᵢ minus the decrease in the present state of charge SOC_{i→s}^{trv} multiplied by the energy rating Eᵢ^{rt} of the battery of the electric vehicle EVᵢ, the updated energy Eₛ^{upd} of the optimal charging station CSₒₚₜ equals the energy available Eₛ^{avl} at the optimal charging station minus an amount of energy delivered E_{s→i}^{giv} by the charging station to the battery of the electric vehicle EVᵢ, the updated energy Eᵢ^{upd} stored in the battery of the electric vehicle EVᵢ after charging must be less than a battery capacity Eᵢ^{rat} of the battery of the electric vehicle EVᵢ, the amount of energy delivered E_{s→i}^{giv} to the battery of the electric vehicle EVᵢ should be greater than the decrease in the present state of charge SOC_{i→s}^{trv} multiplied by the energy rating Eᵢ^{rt} of the battery of the electric vehicle EVᵢ, the total charging response time T_{i,s}^{crs} must be less than or equal to a maximum estimated charging response time, a total number of electric vehicles charging at a charging station CSₛ must be less than or equal to a total number of chargers at the charging station CSₛ, the electric vehicle is one of assigned to an optimal charging station CSₒₚₜ and not assigning to a charging station CSₛ, and the total charging response time T_{i,s}^{crs}, the amount of energy delivered E_{s→i}^{giv} to the battery of the electric vehicle EVᵢ and the updated energy Eᵢ^{upd} are greater than or equal to zero.

The method further includes applying, by the computing device 106, the following constraints in determining the optimal charging station CSₒₚₜ when discharging the battery of the electric vehicle EVᵢ: the electric vehicle EVᵢ is assigned to only one CSₛ, each charging station CSₛ must be able to pay a price for receiving energy from the battery of the electric vehicle EVᵢ, the updated energy Eᵢ^{upd} stored in the battery of the electric vehicle EVᵢ after discharging equals the present state of charge SOCᵢ^{prs} multiplied by the energy rating Eᵢ^{rt} of the battery of the electric vehicle EVᵢ, minus the energy delivered to the optimal CSₒₚₜ by the battery of the electric vehicle EVᵢ, minus the decrease in the present state of charge SOC_{i→s}^{trv} multiplied by the energy rating Eᵢ^{rt} of the battery of the electric vehicle EVᵢ, the updated energy Eₛ^{upd} of the charging station CSₛ must equal an energy present Eₛ^{prs} at the charging station plus an amount of energy generated Eₛ^{ren} by photovoltaic panels connected to the battery of the charging station, plus an amount of energy delivered E_{s→i}^{giv} by the charging station to the battery of the electric vehicle EVᵢ, the updated energy Eₛ^{upd} of the charging station CSₛ must be less than or equal to a rated pool capacity Eₛ^{rat} of the charging station CSₛ, the total discharging response time T_{i,s}^{drs} must be less than or equal to a maximum estimated discharging response time, a total number of electric vehicles discharging at a charging station CSₛ must be less than or equal to a total number of chargers at the charging station CSₛ, the electric vehicle is one of assigned to an optimal charging station CSₒₚₜ and not assigning to a charging station CSₛ, and the total charging response time T_{i,s}^{crs}, the amount of energy delivered E_{s→i}^{giv} to the battery of the electric vehicle EVᵢ and the updated energy Eᵢ^{upd} are greater than zero.

The second embodiment is illustrated with respect to FIGS. 1-3. The second embodiment describes a system 100 for assigning an electric vehicle to a charging station. The system includes a SDN controller application 104 stored in a cloud-based computing platform 102 linked to a plurality of fog servers 114, wherein the SDN controller application 104 is configured to manage network communications between the fog servers 114 and the cloud-based computing platform 102, between the fog servers 114 and a number S of charging stations CSₛ, where s=1, 2, . . . , S, and between the fog and a number I of electric vehicles EVᵢ, where I=1, 2, . . . , I, a computing device 106 stored in the cloud platform, wherein the computing device 106 includes a non-transitory computer readable medium having instructions stored therein which are configured to be executed by one or more processors 110, and a fog and cloud-based charging service application 112 stored in the computing device 106. The fog and cloud-based charging service application 112 is executable by the one or more processors 110 to determine an optimal charging station CSₒₚₜ for each electric vehicle EVᵢ, assign the optimal charging station CSₒₚₜ to the electric vehicle EVᵢ, transmit a route to the optimal charging station CSₒₚₜ to the electric vehicle EVᵢ, receive a notice from the electric vehicle EVᵢ that it has arrived at the optimal charging station CSₒₚₜ, transmit one of a charging command to the optimal charging station CSₒₚₜ to charge a battery of the electric vehicle EVᵢ to a maximum state of charge SOCᵢ^{max} and a discharging command to the optimal charging station CSₒₚₜ to discharge the battery of the EVᵢ to a threshold state of charge SOCᵢ^{thr}, and calculate, by the computing device 106, an updated energy Eᵢ^{upd} stored in the battery of the electric vehicle EVᵢ.

In an aspect, the fog and cloud-based charging service application 112 is further executable by the one or more processors 110 to receive a request from an electric vehicle EVᵢ for a charging station assignment at a time Tᵢ, where i=1, 2, . . . , I, receive a position of the electric vehicle EVᵢ and a route of the electric vehicle EVᵢ, receive a present state of charge SOCᵢ^{prs}, a threshold state of charge SOCᵢ^{thr} and a maximum state of charge SOCᵢ^{max} of a battery of the electric vehicle EVᵢ, identify a number S of charging stations CSₛ, for s=1, 2, . . . , S, along the route of the electric vehicle EVᵢ, calculate a travelling distance dimes of the electric vehicle EVIto each charging station CSₛ, calculate a travelling time T_{i→s}^{trv} for the electric vehicle EVᵢ to travel from the position to each charging station CSₛ, determine a decrease SOC_{i→s}^{trv} in the present state of charge SOCᵢ^{prs} of the battery of the electric vehicle EVᵢ, based on the travelling distance d_{i→s} to each charging station CSₛ, calculate an updated state of charge SOCᵢ^{upd} of the battery of the electric vehicle by subtracting the decrease in the present state of charge SOC_{i→s}^{trv} from the present state of charge SOCᵢ^{prs}, calculate an amount of energy required Eᵢ^{req} to charge the battery of the electric vehicle EVᵢ at each charging station CSₛ based on a difference between a maximum state of charge SOCᵢ^{max} of the EVᵢ and the updated state of charge SOCᵢ^{upd} and multiplying the difference by an energy rating Eᵢ^{rt} of a battery of the electric vehicle EVᵢ, when the updated state of charge SOCᵢ^{upd} is greater than the threshold state of charge SOCᵢ^{thr}, calculate an amount of available energy Eᵢ^{avl} to discharge from the battery to the charging station CSs by multiplying a difference between the updated state of charge SOCᵢ^{upd} and the threshold state of charge SOCᵢ^{thr} by the energy rating Eᵢ^{rt}, receive a vehicle-to-grid, V2G, energy credit and a grid-to-vehicle, G2V, energy cost from each charging station CSₛ, receive from each charging station CSₛ a service charging time T_{i,s}^{ch} to charge the battery of the electric vehicle EVᵢ, receive from each charging station CSₛ a service discharging time T_{i,s}^{dis} to charge the battery of the electric vehicle EVᵢ, receive from each charging station a wait time T_{i,s}^{w} to access a charger, calculate a total charging response time T_{i,s}^{crs} for the battery of the electric vehicle EVᵢ to charge at each charging station, based on the travelling time T_{i→s}^{trv}, the service charging time T_{i,s}^{ch} and the wait time T_{i,s}^{w}, calculate a total discharging response time T_{i,s}^{drs} for the battery of the electric vehicle EVᵢ to discharge at each charging station, based on the travelling time T_{i→s}^{trv}, the service discharging time T_{i,s}^{dis} and the wait time T_{i,s}^{w}, receive an energy available Eₛ^{avl} at each charging station CSₛ, and determine the optimal charging station CSₒₚₜ based at least on one of the amount of energy required Eᵢ^{req} to charge the battery of the electric vehicle EVᵢ at each charging station CSₛ and the amount of energy available Eᵢ^{avl} to discharge battery of the electric vehicle EVᵢ, further based on the V2G energy credit of each charging station CSₛ, the G2V energy cost of each charging station CSₛ, the amount of energy available Eₛ^{avl} at each charging station CSₛ, a minimum total charging response time T_{i,s}^{crs} at each charging station CSₛ, a minimum total discharging response time T_{i,s}^{drs} at each charging station CSₛ, a maximum amount of energy to be delivered to the battery of the electric vehicle EVᵢ and a maximum amount of energy to be delivered to each CSₛ, calculate a satisfaction level of the EVᵢ after one of charging and discharging based on the updated state of charge SOCᵢ^{upd} and the total response time T_{i,s}^{crs} at the optimal charging station CSₒₚₜ.

When the decrease SOC_{i→s}^{trv} in the present state of charge SOCᵢ^{prs} of the battery of the electric vehicle EVᵢ, is greater than or equal to the threshold state of charge SOCᵢ^{thr}, the fog and cloud-based charging service application 112 is further executable by the one or more processors 110 to determine that an optimal charging station CSₒₚₜ cannot be determined, search for mobile charging stations within a specified travelling distance of the electric vehicle EVᵢ, determine a location of each of a plurality of mobile charging stations within the specified travelling distance, determine a travel distance from each mobile charging station to the electric vehicle EVᵢ, identify the mobile charging station which has a shortest travel distance to the electric vehicle EVᵢ, and request that the mobile charging station which has the shortest travel distance travel to the electric vehicle EVᵢ and deliver an amount of energy needed to increase the present state of charge SOCᵢ^{prs} of the battery of the electric vehicle EVᵢ to the maximum state of charge SOCᵢ^{max}.

Further, the fog and cloud-based charging service application 112 is further executable by the one or more processors 110 to identify a charging station which has the minimum total response time T_{i,s}^{crs} of the number S of charging stations CSₛ when an amount of energy available Eₛ^{avl} at each charging station CSₛ is less than the amount of energy needed to increase the present state of charge SOCᵢ^{prs} of the battery of the electric vehicle EVᵢ to the maximum state of charge SOCᵢ^{max}, select the charging station which has the minimum total response time T_{i,s}^{crs} as the optimal charging station CSₒₚₜ, and transmit a command to the optimal charging station CSₒₚₜ which has the minimum total response time T_{i,s}^{crs} to charge the battery of the electric vehicle EVᵢ with energy sourced from a utility grid.

The third embodiment is illustrated with respect to FIGS. 1-3. The third embodiment describes a non-transitory computer readable medium having instructions stored therein that, when executed by one or more processors 110 of a computing device 106 of the fog and cloud-based charging service application, cause the one or more processors 110 to perform a method for assigning an electric vehicle to a charging station. The method includes receiving a request from an electric vehicle EVᵢ for a charging station assignment at a time Tᵢ where i=1, 2, . . . , I, receiving a position of the electric vehicle EVᵢ and a route of the electric vehicle EVᵢ, receiving a present state of charge SOCᵢ^{prs}, a threshold state of charge SOCᵢ^{thr} and a maximum state of charge SOCᵢ^{max} of a battery of the electric vehicle EVᵢ, identifying a number S of charging stations CSₛ, for s=1, 2, . . . , S, along the route of the electric vehicle EVᵢ, calculating a travelling distance d_{i→s} of the electric vehicle EVᵢ to each charging station CSₛ, calculating a travelling time T_{i→s}^{trv} for the electric vehicle EVᵢ to travel from the position to each charging station CSₛ, determining a decrease SOC_{i→s}^{trv} in the present state of charge SOCᵢ^{prs} of the battery of the electric vehicle EVᵢ, based on the travelling distance dimes to each charging station CSₛ, calculating an updated state of charge SOCr d of the battery of the electric vehicle by subtracting the decrease in the present state of charge SOCᵢ^{upd} from the present state of charge SOCᵢ^{prs}, calculating an amount of energy required Eᵢ^{req} to charge the battery of the electric vehicle EVᵢ at each charging station CSₛ based on a difference between a maximum state of charge SOCᵢ^{max} of the EVᵢ and the updated state of charge SOCᵢ^{upd} and multiplying the difference by an energy rating Eᵢ^{rt} of a battery of the electric vehicle EVᵢ, when the updated state of charge SOCᵢ^{upd} is greater than the threshold state of charge SOCᵢ^{thr}, calculating an amount of available energy Eᵢ^{avl} to discharge from the battery to the charging station CSₛ by multiplying a difference between the updated state of charge SOCᵢ^{upd} and the threshold state of charge SOCᵢ^{thr} by the energy rating 0ᵢ^{rt}, receiving a vehicle-to-grid, V2G, energy credit and a grid-to-vehicle, G2V, energy cost from each charging station CSₛ, receiving from each charging station CSₛ a service charging time T_{i,s}^{ch} to charge the battery of the electric vehicle EVᵢ, receiving from each charging station CSₛ a service discharging time T_{i,s}^{dis} to charge the battery of the electric vehicle EVᵢ, receiving from each charging station a wait time T_{i,s}^{w} to access a charger, calculating a total charging response time T_{i,s}^{crs} for the battery of the electric vehicle EVᵢ to charge at each charging station, based on the travelling time T_{i→s}^{trv}, the service charging time T_{i,s}^{ch} and the wait time T_{i,s}^{w}, calculating a total discharging response time T_{i,s}^{drs} for the battery of the electric vehicle EVᵢ to discharge at each charging station, based on the travelling time T_{i→s}^{trv}, the service discharging time T_{i,s}^{dis} and the wait time T_{i,s}^{w}, receiving an energy available Eₛ^{avl} at each charging station CSₛ, determining an optimal charging station CSₒₚₜ based at least on one of the amount of energy required Eᵢ^{req} to charge the battery of the electric vehicle EVᵢ at each charging station CSₛ and the amount of energy available Eᵢ^{avl} to discharge the battery of the electric vehicle EVᵢ, further based on the V2G energy credit of each charging station CSₛ, the G2V energy cost of each charging station CSₛ, the amount of energy available Eₛ^{avl} at each charging station CSₛ, a minimum total response time T_{i,s}^{crs} at each charging station CSₛ, a maximum amount of energy to be delivered to the battery of the electric vehicle EVᵢ and a maximum amount of energy to be delivered to each CSₛ, assigning the optimal charging station CSₒₚₜ to the electric vehicle EVᵢ, transmitting a route to the optimal charging station CSₒₚₜ to the electric vehicle EVᵢ, receiving a notice from the electric vehicle EVᵢ that it has arrived at the optimal charging station CSₒₚₜ, then transmitting one of a charging command to the optimal charging station CSₒₚₜ to charge the battery of the electric vehicle EVᵢ to the maximum state of charge SOCᵢ^{max} and a discharging command to the optimal charging station CSₒₚₜ to discharge the battery of the EVᵢ to the threshold state of charge SOCᵢ^{thr}, and calculating an updated state of charge SOCᵢ^{upd} of the electric vehicle EVᵢ.

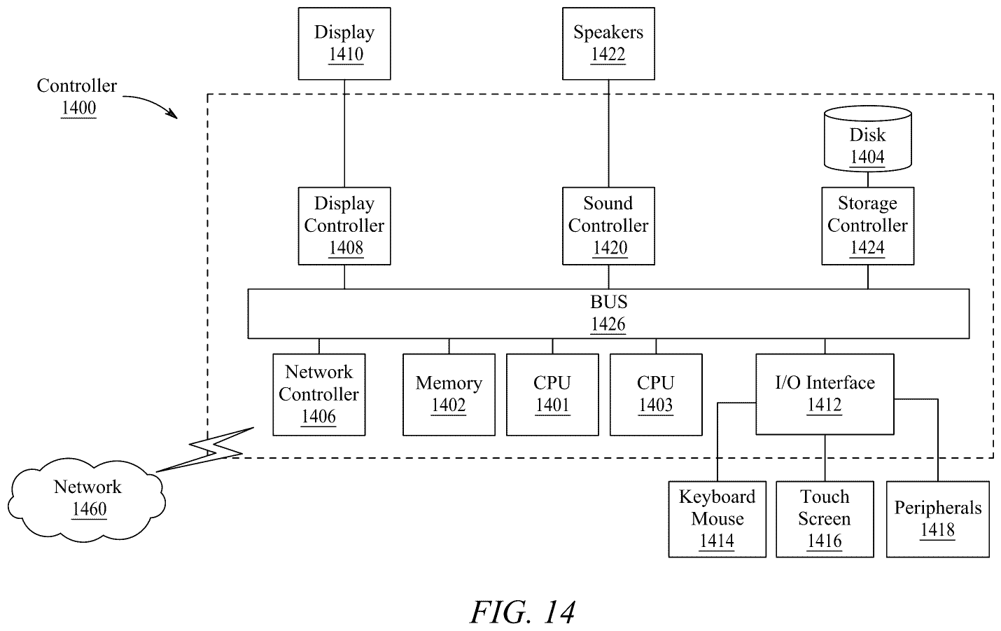

Next, further details of the hardware description of the computing environment of FIG. 1 according to exemplary embodiments are described with reference to FIG. 14. In FIG. 14, a controller 1400 is described as representative of the cloud-based computing platform 102 of FIG. 1 in which the controller is a computing device which includes a CPU 1401 which performs the processes described above/below. The process data and instructions may be stored in memory 1402. These processes and instructions may also be stored on a storage medium disk 1404 such as a hard drive (HDD) or portable storage medium or may be stored remotely.

Further, the claims are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device communicates, such as a server or computer.

Further, the claims may be provided as a utility application, background daemon, or component of an operating system, or combination thereof, executing in conjunction with CPU 1401, 1403 and an operating system such as Microsoft Windows 9, Microsoft Windows 10, UNIX, Solaris, LINUX, Apple MAC-OS and other systems known to those skilled in the art.

The hardware elements in order to achieve the computing device may be realized by various circuitry elements, known to those skilled in the art. For example, CPU 1401 or CPU 1403 may be a Xenon or Core processor from Intel of America or an Opteron processor from AMD of America, or may be other processor types that would be recognized by one of ordinary skilled in the art. Alternatively, the CPU 1401, 1403 may be implemented on an FPGA, ASIC, PLD or using discrete logic circuits, as one of ordinary skilled in the art would recognize. Further, CPU 1401, 1403 may be implemented as multiple processors cooperatively working in parallel to perform the instructions of the inventive processes described above.

The computing device in FIG. 14 also includes a network controller 1406, such as an Intel Ethernet PRO network interface card from Intel Corporation of America, for interfacing with network 1460. As can be appreciated, the network 1460 can be a public network, such as the Internet, or a private network such as an LAN or WAN network, or any combination thereof and can also include PSTN or ISDN sub-networks. The network 1460 can also be wired, such as an Ethernet network, or can be wireless such as a cellular network including EDGE, 3G and 4G wireless cellular systems. The wireless network can also be Wi-Fi, Bluetooth, or any other wireless form of communication that is known.

The computing device further includes a display controller 1408, such as a NVIDIA GeForce GTX or Quadro graphics adaptor from NVIDIA Corporation of America for interfacing with display 1410, such as a Hewlett Packard HPL2445w LCD monitor. A general purpose I/O interface 1412 interfaces with a keyboard and/or mouse 1414 as well as a touch screen panel 1416 on or separate from display 1410. General purpose I/O interface also connects to a variety of peripherals 1418 including printers and scanners, such as an OfficeJet or DeskJet from Hewlett Packard.

A sound controller 1420 is also provided in the computing device such as Sound Blaster X-Fi Titanium from Creative, to interface with speakers/microphone 1422 thereby providing sounds and/or music.

The general purpose storage controller 1424 connects the storage medium disk 1404 with communication bus 1426, which may be an ISA, EISA, VESA, PCI, or similar, for interconnecting all of the components of the computing device. A description of the general features and functionality of the display 1410, keyboard and/or mouse 1414, as well as the display controller 1408, storage controller 1424, network controller 1406, sound controller 1420, and general purpose I/O interface 1412 is omitted herein for brevity as these features are known.

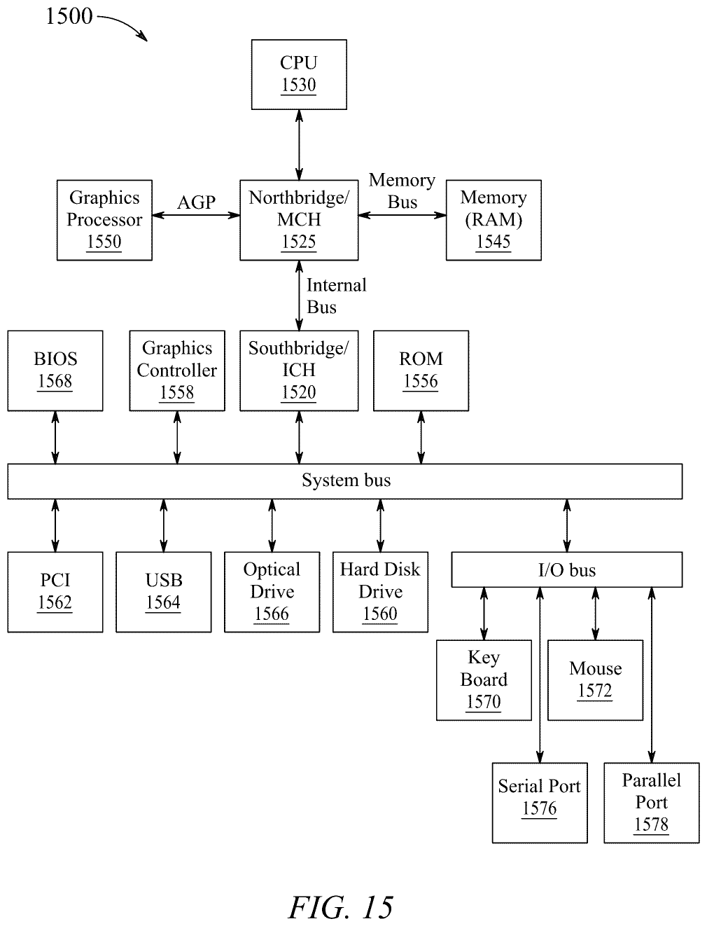

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, as shown on FIG. 15.

FIG. 15 shows a schematic diagram of a data processing system 1500 used within the computing system, according to exemplary aspects of the present disclosure. The data processing system 1500 is an example of a computer in which code or instructions implementing the processes of the illustrative aspects of the present disclosure may be located.

In FIG. 15, data processing system 1500 employs a hub architecture including a north bridge and memory controller hub (NB/MCH) 1525 and a south bridge and input/output (I/O) controller hub (SB/ICH) 1520. The central processing unit (CPU) 1530 is connected to NB/MCH 1525. The NB/MCH 1525 also connects to the memory 1545 via a memory bus, and connects to the graphics processor 1550 via an accelerated graphics port (AGP). The NB/MCH 1525 also connects to the SB/ICH 1520 via an internal bus (e.g., a unified media interface or a direct media interface). The CPU Processing unit 1530 may contain one or more processors and even may be implemented using one or more heterogeneous processor systems.

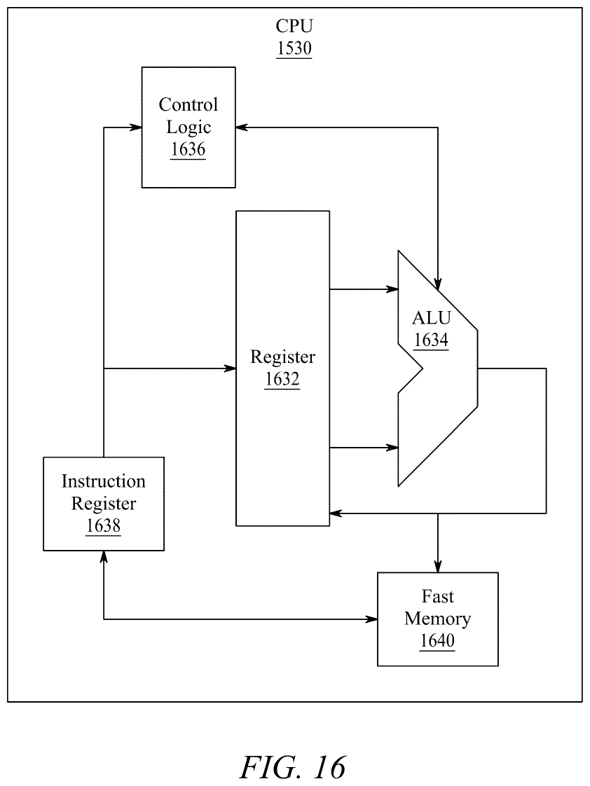

For example, FIG. 16 shows one aspects of the present disclosure of CPU 1530. In one aspects of the present disclosure, the instruction register 1638 retrieves instructions from the fast memory 1640. At least part of these instructions is fetched from the instruction register 1638 by the control logic 1636 and interpreted according to the instruction set architecture of the CPU 1530. Part of the instructions can also be directed to the register 1632. In one aspects of the present disclosure the instructions are decoded according to a hardwired method, and in other aspects of the present disclosure the instructions are decoded according to a microprogram that translates instructions into sets of CPU configuration signals that are applied sequentially over multiple clock pulses. After fetching and decoding the instructions, the instructions are executed using the arithmetic logic unit (ALU) 1634 that loads values from the register 1632 and performs logical and mathematical operations on the loaded values according to the instructions. The results from these operations can be feedback into the register and/or stored in the fast memory 1640. According to certain aspects of the present disclosures, the instruction set architecture of the CPU 1530 can use a reduced instruction set architecture, a complex instruction set architecture, a vector processor architecture, a very large instruction word architecture. Furthermore, the CPU 1530 can be based on the Von Neuman model or the Harvard model. The CPU 1530 can be a digital signal processor, an FPGA, an ASIC, a PLA, a PLD, or a CPLD. Further, the CPU 1530 can be an x86 processor by Intel or by AMD; an ARM processor, a Power architecture processor by, e.g., IBM; a SPARC architecture processor by Sun Microsystems or by Oracle; or other known CPU architecture.

Referring again to FIG. 15, the data processing system 1500 can include that the SB/ICH 1520 is coupled through a system bus to an I/O Bus, a read only memory (ROM) 1556, universal serial bus (USB) port 1564, a flash binary input/output system (BIOS) 1568, and a graphics controller 1558. PCI/PCIe devices can also be coupled to SB/ICH 1520 through a PCI bus 1562.

The PCI devices may include, for example, Ethernet adapters, add-in cards, and PC cards for notebook computers. The Hard disk drive 1560 and CD-ROM 1556 can use, for example, an integrated drive electronics (IDE) or serial advanced technology attachment (SATA) interface. In one aspects of the present disclosure the I/O bus can include a super I/O (SIO) device.

Further, the hard disk drive (HDD) 1560 and optical drive 1566 can also be coupled to the SB/ICH 1520 through a system bus. In one aspects of the present disclosure, a keyboard 1570, a mouse 1572, a parallel port 1578, and a serial port 1576 can be connected to the system bus through the I/O bus. Other peripherals and devices that can be connected to the SB/ICH 1620 using a mass storage controller such as SATA or PATA, an Ethernet port, an ISA bus, an LPC bridge, SMBus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry or based on the requirements of the intended back-up load to be powered.

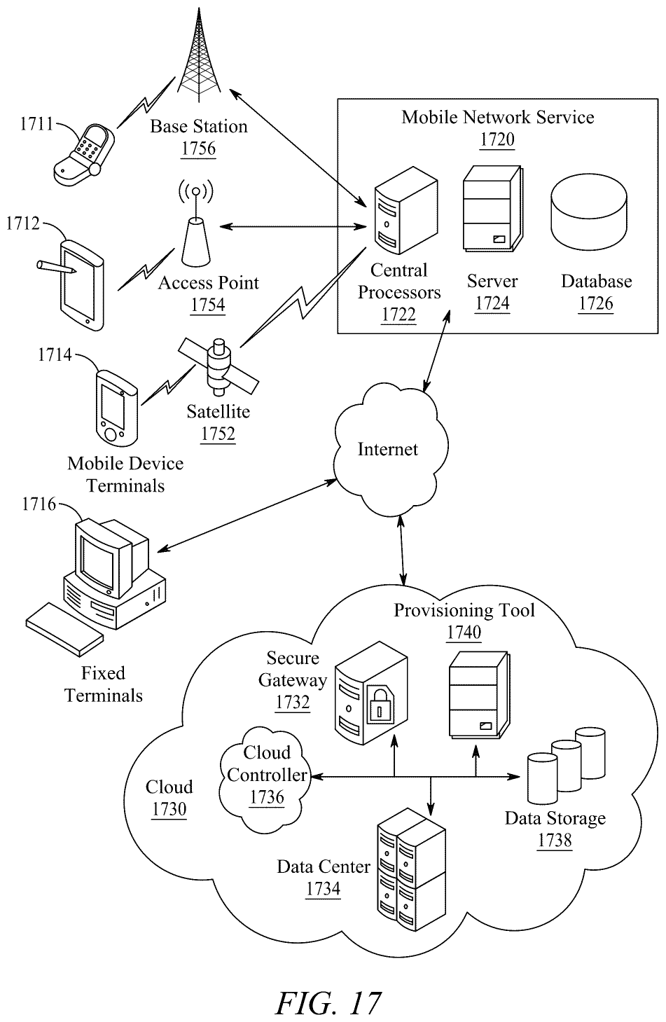

The functions and features described herein may also be executed by various distributed components of a system. For example, one or more processors may execute these system functions, wherein the processors are distributed across multiple components communicating in a network. The distributed components may include one or more client and server machines, which may share processing, as shown by FIG. 17, in addition to various human interface and communication devices (e.g., display monitors, smart phones, tablets, personal digital assistants (PDAs)). More specifically, FIG. 17 illustrates client devices including a smart phone 1711, a tablet 1712, a mobile device terminal 1714 and fixed terminals 1716. These client devices may be commutatively coupled with a mobile network service 1720 via base station 1756, access point 1754, satellite 1752 or via an internet connection. Mobile network service 1720 may comprise central processors 1722, a server 1724 and a database 1726. Fixed terminals 1716 and mobile network service 1720 may be commutatively coupled via an internet connection to functions in cloud 1730 that may comprise security gateway 1732, a data center 1734, a cloud controller 1736, a data storage 1738 and a provisioning tool 1740. The network may be a private network, such as a LAN or WAN, or may be a public network, such as the Internet. Input to the system may be received via direct user input and received remotely either in real-time or as a batch process. Additionally, some aspects of the present disclosures may be performed on modules or hardware not identical to those described. Accordingly, other aspects of the present disclosures are within the scope that may be claimed.

The above-described hardware description is a non-limiting example of corresponding structure for performing the functionality described herein.

Obviously, numerous modifications and variations of the present disclosure are possible in light of the above teachings. It is therefore to be understood that within the scope of the appended claims, the invention may be practiced otherwise than as specifically described herein.

1. A method for assigning an electric vehicle to a charging station by a fog and cloud-based charging service application, comprising:
receiving, by a computing device of the fog and cloud-based charging service application, a request from an electric vehicle EVᵢ for a charging station assignment at a time Tᵢ, where i=1, 2, . . . , I;
receiving, by the computing device, a position of the electric vehicle EVᵢ and a route of the electric vehicle EVᵢ;
receiving, by the computing device, a present state of charge SOCᵢ^{prs}, a threshold state of charge SOCᵢ^{thr} and a maximum state of charge SOCᵢ^{max} of a battery of the electric vehicle EVᵢ;
identifying, by the computing device, a number S of charging stations CSₛ, for s=1, 2, . . . , S, along the route of the electric vehicle EVᵢ;
calculating, by the computing device, a travelling distance dimes of the electric vehicle EVᵢ to each charging station CSₛ;
calculating, by the computing device, a travelling time T_{i→S}^{trv} for the electric vehicle EVᵢ to travel from the position to each charging station CSₛ;
determining, by the computing device, a decrease SOC_{i→S}^{trv} in the present state of charge SOCᵢ^{prs} of the battery of the electric vehicle EVᵢ, based on the travelling distance dimes to each charging station CSₛ;
calculating, by the computing device, an updated state of charge SOCᵢ^{upd} of the battery of the electric vehicle by subtracting the decrease in the present state of charge SOC_{i→S}^{trv} from the present state of charge SOCᵢ^{prs};
calculating, by the computing device, an amount of energy required Eᵢ^{req} to charge the battery of the electric vehicle EVᵢ at each charging station CSₛ based on a difference between a maximum state of charge SOCᵢ^{max} of the EVᵢ and the updated state of charge SOCᵢ^{upd} and multiplying the difference by an energy rating Eᵢ^{rt} of a battery of the electric vehicle EVᵢ;
when the updated state of charge SOCᵢ^{upd} is greater than the threshold state of charge SOCᵢ^{thr}, calculating an amount of available energy Eᵢ^{avl} to discharge from the battery to the charging station CSₛ by multiplying a difference between the updated state of charge SOCᵢ^{upd} and the threshold state of charge SOCᵢ^{thr} by the energy rating Eᵢ^{rt};
receiving, by the computing device, a vehicle-to-grid, V2G, energy credit and a grid-to-vehicle, G2V, energy cost from each charging station CSₛ;
receiving, by the computing device, from each charging station CSₛ a service charging time T_{i,s}^{ch} to charge the battery of the electric vehicle EVᵢ;
receiving, by the computing device, from each charging station CSₛ a service discharging time T_{i,s}^{dis} to charge the battery of the electric vehicle EVᵢ;
receiving, by the computing device, from each charging station a wait time T_{i,s}^{w} to access a charger;
calculating, by the computing device, a total charging response time T_{i,s}^{crs} for the battery of the electric vehicle EVᵢ to charge at each charging station, based on the travelling time T_{i→s}^{trv}, the service charging time T_{i,s}^{ch} and the wait time T_{i,s}^{w};
calculating, by the computing device, a total discharging response time T_{i,s}^{drs} for the battery of the electric vehicle EVᵢ to discharge at each charging station, based on the travelling time T_{i→s}^{trv}, the service discharging time T_{i,s}^{dis} and the wait time T_{i,s}^{w};
receiving, by the computing device, an energy available Eₛ^{avl} at each charging station CSₛ;
determining, by the computing device, an optimal charging station, CSₒₚₜ, based at least on one of the amount of energy required Eᵢ^{req} to charge the battery of the electric vehicle EVᵢ at each charging station CSₛ and the amount of energy available Eᵢ^{avl} to discharge the battery of the electric vehicle EVᵢ; further based on the V2G energy credit of each charging station CSₛ, the G2V energy cost of each charging station CSₛ, the amount of energy available Eₛ^{avl} at each charging station CSₛ, a minimum total charging response time T_{i,s}^{crs} at each charging station CSₛ, a minimum total discharging response time T_{i,s}^{drs} at each charging station CSₛ, a maximum amount of energy to be delivered to the battery of the electric vehicle EVᵢ and a maximum amount of energy to be delivered to each CSₛ;
assigning the optimal charging station CSₒₚₜ to the electric vehicle EVᵢ;
transmitting, by the computing device, a route to the optimal charging station CSₒₚₜ to the electric vehicle EVᵢ;
receiving, by the computing device, a notice from the electric vehicle EVᵢ that it has arrived at the optimal charging station CSₒₚₜ;
then, transmitting, by the computing device, one of a charging command to the optimal charging station CSₒₚₜ to charge the battery of the electric vehicle EVᵢ to the maximum state of charge SOCᵢ^{max} and a discharging command to the optimal charging station CSₒₚₜ to discharge the battery of the EVᵢ to the threshold state of charge SOCᵢ^{thr}; and
calculating, by the computing device, an updated energy Eᵢ^{upd} stored in the battery of the electric vehicle EVᵢ.

2. The method of claim 1, further comprising:
receiving, by the computing device, a rated energy capacity of each charging station CSₛ and a total number of electric vehicles charging at each charging station CSₛ; and
estimating, by the computing device, whether the rated energy capacity of each charging station CSₛ is sufficient to provide the required energy to charge the battery of the electric vehicle to the maximum state of charge SOCᵢ^{max}.

3. The method of claim 1, further comprising:
when the updated state of charge SOCᵢ^{upd} is greater than the threshold state of charge SOCᵢ^{thr}, calculating, by the computing device, a credit for the electric vehicle to discharge its energy to the threshold state of charge SOCᵢ^{thr} at the each charging station CSₛ and determining which charging station CSₛ offers the highest energy credit;
when the updated state of charge SOCᵢ^{upd} is less than or equal to the threshold state of charge SOCᵢ^{thr}, calculating, by the computing device, an energy cost to charge the battery of the electric vehicle EVᵢ to its maximum state of charge SOCᵢ^{max} at each charging station CSₛ, and determining which charging station has the lowest energy cost; and
determining, by the computing device, the optimal charging station CSₒₚₜ based at least on one of the highest energy credit and the lowest energy cost.

4. The method of claim 1, further comprising:
calculating, by the computing device, a satisfaction level of the EVᵢ after one of charging and discharging based on the updated state of charge SOCᵢ^{upd} and the total response time T_{i,s}^{crs} at the optimal charging station CSₒₚₜ.

5. The method of claim 4, further comprising:
receiving, by the computing device, a first satisfaction level weight α and a second satisfaction level weight β;
generating, by the computing device, a charging energy factor by dividing the updated state of charge SOCᵢ^{upd} by the energy rating Eᵢ^{rt};
generating, by the computing device, a charging time factor by dividing a time slot available T_{i,s}^{avl} at the optimal CSₒₚₜ, by the total response time T_{i,s}^{crs};
multiplying, by the computing device, the charging energy factor by the first satisfaction level weight α and generating a weighted charging energy factor;
multiplying, by the computing device, the charging time factor by the second satisfaction level weight α and generating a weighted charging time factor; and
calculating a charging satisfaction level Sᵢ^{ch} of the EVᵢ by adding the weighted charging energy factor to the weighted charging time factor.

6. The method of claim 5, further comprising:
estimating, by the computing device, an estimated charging satisfaction level S_{i,est}^{ch} of the EVᵢ at each CSₛ; and
calculating the optimal charging station CSₛ based in part on the estimated charging satisfaction level S_{i,est}^{ch} of the EVᵢ.

7. The method of claim 4, further comprising:
receiving, by the computing device, a first satisfaction level weight a and a second satisfaction level weight β;
generating, by the computing device, a discharging energy factor by dividing the energy discharged E_{i→s}^{giv} by the electric vehicle EVito the optimal charging station CSₛ by the amount of available energy Eᵢ^{avl} in the battery of the electric vehicle EVᵢ;
generating, by the computing device, a discharging time factor by dividing a time slot available T_{i,s}^{avl} at the optimal charging station CSₒₚₜ, by the total discharging response time T_{i,s}^{drs};
multiplying, by the computing device, the discharging energy factor by the first satisfaction level weight a and generating a weighted discharging energy factor;
multiplying, by the computing device, the discharging time factor by the second satisfaction level weight a and generating a weighted discharging time factor; and
calculating a discharging satisfaction level Sᵢ^{dis} of the EVᵢ by adding the weighted discharging energy factor to the weighted discharging time factor.

8. The method of claim 7, further comprising:
estimating, by the computing device, an estimated discharging satisfaction level S_{i,est}^{dis} of the EVᵢ at each CSₛ; and
calculating the optimal charging station CSₛ based in part on the estimated discharging satisfaction level S_{i,est}^{dis} of the EVᵢ.

9. The method of claim 1, further comprising:
when the decrease SOC_{i→s}^{trv} in the present state of charge SOCᵢ^{prs} of the battery of the electric vehicle EVᵢ, is greater than or equal to the threshold state of charge SOCᵢ^{thr}, determining, by the computing device, that an optimal charging station CSₒₚₜ cannot be determined;
searching, by the computing device, for mobile charging stations within a selected distance of the electric vehicle EVᵢ;
determining, by the computing device, a location of each of a plurality of mobile charging stations within the selected distance;
determining, by the computing device, a travel distance from each mobile charging station to the electric vehicle EVᵢ;
identifying, by the computing device, the mobile charging station which has a shortest travel distance to the electric vehicle EVᵢ; and
requesting, by the computing device, that the mobile charging station which has the shortest travel distance travel to the electric vehicle EVᵢ and deliver an amount of energy needed to increase the present state of charge SOCᵢ^{prs} of the battery of the electric vehicle EVᵢ to the maximum state of charge SOCᵢ^{max}.

10. The method of claim 1, wherein the energy available at each charging station CSₛ is stored in a charging station battery, which is recharged by energy generated by a plurality of photovoltaic panels and by energy received from discharging electric vehicles.

11. The method of claim 10, further comprising:
when an amount of energy available Eₛ^{avl} at each charging station CSₛ is less than the amount of energy needed to increase the present state of charge SOCᵢ^{prs} of the battery of the electric vehicle EVᵢ to the maximum state of charge SOCᵢ^{max}, identifying, by the computing device, a charging station which has the minimum total response time T_{i,s}^{crs} of the number S of charging stations CSₛ;
selecting the charging station which has the minimum total response time T_{i,s}^{crs} as the optimal charging station CSₒₚₜ; and
transmitting, by the computing device, a command to the optimal charging station CSₒₚₜ which has the minimum total response time T_{i,s}^{crs} to charge the battery of the electric vehicle EVᵢ with energy sourced from a utility grid.

12. The method of claim 1, further comprising:
registering, by the computing device, each electric vehicle EVᵢ for all i=1, 2, . . . , I with the fog and cloud-based charging service application; and
registering, by the computing device, each charging station CSₛ for all s=1, 2, . . . , S with the fog and cloud-based charging service application.

13. The method of claim 1, wherein the fog and cloud-based charging service application further comprises a software-defined networking (SDN) controller application configured to manage network communications of the fog and cloud-based charging service application.

14. The method of claim 1, further comprising:
applying, by the computing device, the following constraints in determining the optimal charging station CSₒₚₜ when charging the battery of the electric vehicle EVᵢ:
the electric vehicle EVᵢ is assigned to only one CSₛ;
a total energy transferred to the batteries of all electric vehicles assigned to a charging station CSₛ is less than or equal to the available energy Eₛ^{avl} of the CSₛ;
the electric vehicle EVᵢ must be able to pay a price for charging its battery;
the updated energy Eᵢ^{upd} stored in the battery of the electric vehicle EVᵢ after charging equals the present state of charge SOCᵢ^{prs} multiplied by the energy rating Eᵢ^{rt} of the battery of the electric vehicle EVᵢ, plus the energy delivered by the optimal CSₒₚₜ to the battery of the electric vehicle EVᵢ minus the decrease in the present state of charge SOC_{i→s}^{trv} multiplied by the energy rating Eᵢ^{rt} of the battery of the electric vehicle EVᵢ;
the updated energy Eₛ^{upd} of the optimal charging station CSₒₚₜ equals the energy available Eₛ^{avl} at the optimal charging station minus an amount of energy delivered E_{s→i}^{giv} by the charging station to the battery of the electric vehicle EVᵢ;
the updated energy Eᵢ^{upd} stored in the battery of the electric vehicle EVᵢ after charging must be less than a battery capacity Eᵢ^{rat} of the battery of the electric vehicle EVᵢ;
the amount of energy delivered E_{s→i}^{giv} to the battery of the electric vehicle EVᵢ should be greater than the decrease in the present state of charge SOC_{i→s}^{trv} multiplied by the energy rating Eᵢ^{rt} of the battery of the electric vehicle EVᵢ;
the total charging response time T_{i,s}^{crs} must be less than or equal to a maximum estimated charging response time;
a total number of electric vehicles charging at a charging station CSₛ must be less than or equal to a total number of chargers at the charging station CSₛ;
the electric vehicle is one of assigned to an optimal charging station CSₒₚₜ and not assigning to a charging station CSₛ; and
the total charging response time T_{i,s}^{crs}, the amount of energy delivered E_{s→i}^{giv} to the battery of the electric vehicle EVᵢ and the updated energy Eᵢ^{upd} are greater than or equal to zero.

15. The method of claim 1, further comprising:
applying, by the computing device, the following constraints in determining the optimal charging station CSₒₚₜ when discharging the battery of the electric vehicle EVᵢ:
the electric vehicle EVᵢ is assigned to only one CSₛ;
each charging station CSₛ must be able to pay a price for receiving energy from the battery of the electric vehicle EVᵢ;
the updated energy Eᵢ^{upd} stored in the battery of the electric vehicle EVᵢ after discharging equals the present state of charge SOCᵢ^{prs} multiplied by the energy rating Eᵢ^{rt} of the battery of the electric vehicle EVᵢ, minus the energy delivered to the optimal CSₒₚₜ by the battery of the electric vehicle EVᵢ, minus the decrease in the present state of charge SOC_{i→s}^{trv} multiplied by the energy rating Eᵢ^{rt} of the battery of the electric vehicle EVᵢ;
the updated energy Eₛ^{upd} of the charging station CSₛ must equal an energy present Eₛ^{prs} at the charging station plus an amount of energy generated Eₛ^{ren} by photovoltaic panels connected to the battery of the charging station, plus an amount of energy delivered E_{s→i}^{giv} by the charging station to the battery of the electric vehicle EVᵢ;
the updated energy Eₛ^{upd} of the charging station CSₛ must be less than or equal to a rated pool capacity Eₛ^{rat} at of the charging station CSₛ;
the total discharging response time T_{i,s}^{drs} must be less than or equal to a maximum estimated discharging response time;
a total number of electric vehicles discharging at a charging station CSₛ must be less than or equal to a total number of chargers at the charging station CSₛ;
the electric vehicle is one of assigned to an optimal charging station CSₒₚₜ and not assigning to a charging station CSₛ; and
the total charging response time T_{i,s}^{crs}, the amount of energy delivered E_{s→i}^{giv} to the battery of the electric vehicle EVᵢ and the updated energy Eᵢ^{upd} are greater than zero.

16. A system for assigning an electric vehicle to a charging station, comprising:
a software-defined networking (SDN) controller application stored in a cloud-based computing platform linked to a plurality of fog servers, wherein the SDN controller application is configured to manage network communications between the fog servers and the cloud-based computing platform, between the plurality of fog servers and a number S of charging stations CSₛ, where s=1, 2, . . . , S, and between the plurality of fog servers and a number I of electric vehicles EVᵢ, where I=1, 2, . . . , I;
a computing device stored in the cloud platform, wherein the computing device includes a non-transitory computer readable medium having instructions stored therein which are configured to be executed by one or more processors;
a fog and cloud-based charging service application stored in the computing device, wherein the fog and cloud-based charging service application is executable by the one or more processors to:
determine an optimal charging station CSₒₚₜ for each electric vehicle EVᵢ;
assign the optimal charging station CSₒₚₜ to the electric vehicle EVᵢ;
transmit a route to the optimal charging station CSₒₚₜ to the electric vehicle EVᵢ;
receive a notice from the electric vehicle EVᵢ that it has arrived at the optimal charging station CSₒₚₜ;
transmit one of a charging command to the optimal charging station CSₒₚₜ to charge a battery of the electric vehicle EVᵢ to a maximum state of charge SOCᵢ^{max} and a discharging command to the optimal charging station CSₒₚₜ to discharge the battery of the EVᵢ to a threshold state of charge SOCᵢ^{thr}; and
calculate, by the computing device, an updated energy Eᵢ^{upd} stored in the battery of the electric vehicle EVᵢ.

17. The system of claim 16, wherein the fog and cloud-based charging service application is further executable by the one or more processors to:
receive a request from an electric vehicle EVᵢ for a charging station assignment at a time Tᵢ, where i=1, 2, . . . , I;
receive a position of the electric vehicle EVᵢ and a route of the electric vehicle EVᵢ;
receive a present state of charge SOCᵢ^{prs}, a threshold state of charge SOCᵢ^{thr} and a maximum state of charge SOCᵢ^{max} of a battery of the electric vehicle EVᵢ;
identify a number S of charging stations CSₛ, for s=1, 2, . . . , S, along the route of the electric vehicle EVᵢ;
calculate a travelling distance d_{i→s} of the electric vehicle EVᵢ to each charging station CSₛ;
calculate a travelling time T_{i→s}^{trv} for the electric vehicle EVᵢ to travel from the position to each charging station CSₛ;
determine a decrease SOC_{i→s}^{trv} in the present state of charge SOCᵢ^{prs} of the battery of the electric vehicle EVᵢ, based on the travelling distance d_{i→s} to each charging station CSₛ;
calculate an updated state of charge SOCᵢ^{upd} of the battery of the electric vehicle by subtracting the decrease in the present state of charge SOC_{i→s}^{trv} from the present state of charge SOCᵢ^{prs};
calculate an amount of energy required Eᵢ^{req} to charge the battery of the electric vehicle EVᵢ at each charging station CSₛ based on a difference between a maximum state of charge SOCᵢ^{max} of the EVᵢ and the updated state of charge SOCᵢ^{upd} and multiplying the difference by an energy rating Eᵢ^{rt} of a battery of the electric vehicle EVᵢ;
when the updated state of charge SOCᵢ^{upd} is greater than the threshold state of charge SOCᵢ^{thr}, calculate an amount of available energy Eᵢ^{avl} to discharge from the battery to the charging station CSₛ by multiplying a difference between the updated state of charge SOCᵢ^{upd} and the threshold state of charge SOCᵢ^{thr} by the energy rating Eᵢ^{rt};
receive a vehicle-to-grid, V2G, energy credit and a grid-to-vehicle, G2V, energy cost from each charging station CSₛ;
receive from each charging station CSₛ a service charging time T_{i,s}^{ch} to charge the battery of the electric vehicle EVᵢ;
receive from each charging station CSₛ a service discharging time T_{i,s}^{dis} to charge the battery of the electric vehicle EVᵢ;
receive from each charging station a wait time T_{i,s}^{w} to access a charger;
calculate a total charging response time T_{i,s}^{crs} for the battery of the electric vehicle EVᵢ to charge at each charging station, based on the travelling time T_{i→s}^{trv}, the service charging time T_{i,s}^{ch} and the wait time T_{i,s}^{w};
calculate a total discharging response time T_{i,s}^{drs} for the battery of the electric vehicle EVᵢ to discharge at each charging station, based on the travelling time T_{i→s}^{trv}, the service discharging time T_{i,s}^{dis} and the wait time T_{i,s}^{w};
receive an energy available Eₛ^{avl} at each charging station CSₛ; and
determine the optimal charging station CSₒₚₜ based at least on one of the amount of energy required Eᵢ^{req} to charge the battery of the electric vehicle EVᵢ at each charging station CSₛ and the amount of energy available Eᵢ^{avl} to discharge battery of the electric vehicle EVᵢ; further based on the V2G energy credit of each charging station CSₛ, the G2V energy cost of each charging station CSₛ, the amount of energy available Eₛ^{avl} at each charging station CSₛ, a minimum total charging response time T_{i,s}^{crs} at each charging station CSₛ, a minimum total discharging response time T_{i,s}^{drs} at each charging station CSₛ, a maximum amount of energy to be delivered to the battery of the electric vehicle EVᵢ and a maximum amount of energy to be delivered to each CSₛ;
calculate a satisfaction level of the EVᵢ after one of charging and discharging based on the updated state of charge SOCᵢ^{upd} and the total response time T_{i,s}^{crs} at the optimal charging station CSₒₚₜ.

18. The system of claim 17, wherein the fog and cloud-based charging service application is further executable by the one or more processors to:
when the decrease SOC_{i→s}^{trv} in the present state of charge SOCᵢ^{prs} of the battery of the electric vehicle EVᵢ, is greater than or equal to the threshold state of charge SOCᵢ^{thr}, determine that an optimal charging station CSₒₚₜ cannot be determined;
searching for mobile charging stations within a selected distance of the electric vehicle EVᵢ;
determine a location of each of a plurality of mobile charging stations within the selected distance;
determine a travel distance from each mobile charging station to the electric vehicle EVᵢ;
identify the mobile charging station which has a shortest travel distance to the electric vehicle EVᵢ; and
request that the mobile charging station which has the shortest travel distance travel to the electric vehicle EVᵢ and deliver an amount of energy needed to increase the present state of charge SOCᵢ^{prs} of the battery of the electric vehicle EVᵢ to the maximum state of charge SOCᵢ^{max}.

19. The system of claim 18, wherein the fog and cloud-based charging service application is further executable by the one or more processors to:
when an amount of energy available Eₛ^{avl} at each charging station CSₛ is less than the amount of energy needed to increase the present state of charge SOCᵢ^{prs} of the battery of the electric vehicle EVᵢ to the maximum state of charge SOCᵢ^{max}, identify a charging station which has the minimum total response time T_{i,s}^{crs} of the number S of charging stations CSₛ;
select the charging station which has the minimum total response time T_{i,s}^{crs} as the optimal charging station CSₒₚₜ; and
transmit a command to the optimal charging station CSₒₚₜ which has the minimum total response time T_{i,s}^{crs} to charge the battery of the electric vehicle EVᵢ with energy sourced from a utility grid.

20. A non-transitory computer readable medium having instructions stored therein that, when executed by one or more processors of a computing device of the fog and cloud-based charging service application, cause the one or more processors to perform a method for assigning an electric vehicle to a charging station, comprising:
receiving a request from an electric vehicle EVᵢ for a charging station assignment at a time Tᵢ where i=1, 2, . . . , I;
receiving a position of the electric vehicle EVᵢ and a route of the electric vehicle EVᵢ;
receiving a present state of charge SOCᵢ^{prs}, a threshold state of charge SOCᵢ^{thr} and a maximum state of charge SOCᵢ^{max} of a battery of the electric vehicle EVᵢ;
identifying a number S of charging stations CSₛ, for s=1, 2, . . . , S, along the route of the electric vehicle EVᵢ;
calculating a travelling distance d_{i→s} of the electric vehicle EVᵢ to each charging station CSₛ;
calculating a travelling time T_{i→s}^{trv} for the electric vehicle EVᵢ to travel from the position to each charging station CSₛ;
determining a decrease SOC_{i→s}^{trv} in the present state of charge SOCᵢ^{prs} of the battery of the electric vehicle EVᵢ, based on the travelling distance dimes to each charging station CSₛ;
calculating an updated state of charge SOCᵢ^{upd} of the battery of the electric vehicle by subtracting the decrease in the present state of charge SOC_{i→s}^{trv} from the present state of charge SOCᵢ^{prs};
calculating an amount of energy required Eᵢ^{req} to charge the battery of the electric vehicle EVᵢ at each charging station CSₛ based on a difference between a maximum state of charge SOCᵢ^{max} of the EVᵢ and the updated state of charge SOCᵢ^{upd} and multiplying the difference by an energy rating Eᵢ^{rt} of a battery of the electric vehicle EVᵢ;
when the updated state of charge SOCᵢ^{upd} is greater than the threshold state of charge SOCᵢ^{thr}, calculating an amount of available energy Eᵢ^{avl} to discharge from the battery to the charging station CSₛ by multiplying a difference between the updated state of charge SOCᵢ^{upd} and the threshold state of charge SOCᵢ^{thr} by the energy rating Eᵢ^{rt};
receiving a vehicle-to-grid, V2G, energy credit and a grid-to-vehicle, G2V, energy cost from each charging station CSₛ;
receiving from each charging station CSₛ a service charging time T_{i,s}^{ch} to charge the battery of the electric vehicle EVᵢ;
receiving from each charging station CSₛ a service discharging time T_{i,s}^{dis} to charge the battery of the electric vehicle EVᵢ;
receiving from each charging station a wait time T_{i,s}^{w} to access a charger;
calculating a total charging response time T_{i,s}^{crs} for the battery of the electric vehicle EVᵢ to charge at each charging station, based on the travelling time T_{i→s}^{trv}, the service charging time T_{i,s}^{ch} and the wait time T_{i,s}^{w};
calculating a total discharging response time T_{i,s}^{drs} for the battery of the electric vehicle EVᵢ to discharge at each charging station, based on the travelling time T_{i→s}^{trv}, the service discharging time T_{i,s}^{dis} and the wait time T_{i,s}^{w};
receiving an energy available Eₛ^{avl} at each charging station CSₛ;
determining an optimal charging station CSₒₚₜ based at least on one of the amount of energy required Eᵢ^{req} to charge the battery of the electric vehicle EVᵢ at each charging station CSₛ and the amount of energy available Eᵢ^{avl} to discharge the battery of the electric vehicle EVᵢ; further based on the V2G energy credit of each charging station CSₛ, the G2V energy cost of each charging station CSₛ, the amount of energy available Eₛ^{avl} at each charging station CSₛ, a minimum total response time T_{i,s}^{crs} at each charging station CSₛ, a maximum amount of energy to be delivered to the battery of the electric vehicle EVᵢ and a maximum amount of energy to be delivered to each CSₛ;
assigning the optimal charging station CSₒₚₜ to the electric vehicle EVᵢ;
transmitting a route to the optimal charging station CSₒₚₜ to the electric vehicle EVᵢ;
receiving a notice from the electric vehicle EVᵢ that it has arrived at the optimal charging station CSₒₚₜ;
then, transmitting one of a charging command to the optimal charging station CSₒₚₜ to charge the battery of the electric vehicle EVᵢ to the maximum state of charge SOCᵢ^{max} and a discharging command to the optimal charging station CSₒₚₜ to discharge the battery of the EVᵢto the threshold state of charge SOCᵢ^{thr}; and
calculating an updated state of charge of the electric vehicle EVᵢ.
